(19) United States
(12) Patent Application Publication
(10) Pub. No.: US 2017/0220283 A1
(43) Pub. Date: Aug. 3, 2017

(54) REDUCING MEMORY USAGE BY A DECODER DURING A FORMAT CHANGE

(71) Applicant: Microsoft Technology Licensing, LLC, Redmond, WA (US)

(72) Inventors: Wenbo Zhang, Sammamish, WA (US); Shyam Sadhwani, Bellevue, WA (US); Sudhakar Prabhu, Bellevue, WA (US); Yongjun Wu, Bellevue, WA (US)

(21) Appl. No.: 15/011,085

(22) Filed: Jan. 29, 2016

(51) Int. Cl. G06F 3/06; H04N 19/184

(52) U.S. Cl. CPC G06F 3/0631; G06F 3/0604; G06F 3/0656; G06F 3/0673; H04N 19/184

(57) ABSTRACT

Techniques and systems for reducing memory usage by a decoder during a format change are disclosed. In a first example technique, discretized memory allocations for new output buffers are sequenced with discretized release operations of previously-allocated memory for previous output buffers in a manner that reduces the amount of in-use memory of a computing device during a format change. In a second example technique, the allocation of new memory for new decoder buffers associated with a new format is conditioned upon the release of previously-allocated memory for decoder buffers associated with a previous format to reduce memory usage during a format change. The first and second techniques, when combined, result in optimized reduction in memory usage by a decoder during a format change.

### BACKGROUND

When encoded media content, such as encoded video content, is received at a computing device for playback, an application, or a browser, on the computing device invokes a decoder to decode the media content so that the media content can be played back (e.g., rendered on a display). Decoding media content can be a memory intensive process, especially for media content, such as video, that is transmitted and stored using a significant number of bits. For example, when a video application on a computing devices is used to stream video over the Internet, memory usage of the computing device increases significantly when decoding operations are performed. In many client computing devices with limited memory capacity, it is desirable to minimize the amount of in-use memory during the execution of a video application on the computing device. For example, if memory usage increases to an undesirable level during video playback, the video can freeze or lag during playback, or even worse, the computing device can run out of memory, causing the video application to exit or a crash.

A decoding scenario where the memory usage of a computing device can more than double is during a format change from a first format to a second, different format. For example, video content can be initially received in a low resolution and low bitrate format in order to render the video content more quickly on a display, and then a latter portion of the video content can be subsequently received in a high resolution and high bitrate format for better quality rendering as the video playback continues. Such changes can happen frequently based on network bandwidth (e.g., changing to low resolution and low bitrate video when network bandwidth worsens, and changing to high resolution and high bitrate video when network bandwidth improves). The main reason why such a format change causes peak memory usage is that the video decoder of the computing device is configured to allocate memory in a single process call for all decoding resources to be used for a new format while previously-allocated memory is still being used for decoding and rendering the video of the first format. In other words, for a period of time during a format transition from one format to another format, memory is allocated and used for all decoding resources of both formats simultaneously, causing the memory usage of the computing device to spike during a format change.

### SUMMARY

Described herein are techniques and systems for reducing memory usage by a decoder during a format change. In some implementations, discretized memory allocations for new output buffers (i.e., buffers that maintain decoded video content to be rendered on a display) are sequenced with discretized release operations of previously-allocated memory in a manner that reduces the amount of in-use memory of a computing device during a transition period from a first format to a second, different format of the media content. Sequencing the allocation of new memory and the release of previously-allocated memory can comprise interleaving allocation and release operations so that a portion of new memory for a second format is allocated in response to a portion of previously-allocated memory for a first format being released. In some configurations, in response to rendering video content of a first format on a display, a portion of first memory allocated for a first output buffer associated with the first format is released, causing a reduction of in-use memory of the computing device. A video decoder of the computing device is configured to receive an indication that the amount of in-use memory is below a threshold amount, which triggers the discretized allocation of second memory for a second output buffer associated with a second format. In this manner, the allocation of second memory for decoding and rendering media encoded in a second format can be staggered (i.e., not allocated all at once) so that the system maintains an amount of in-use memory at a desirable level (e.g., below a threshold amount of in-use memory).

In some configurations, a release operation for decoder buffers (i.e., internal decoder buffers that maintain decoded video content and information used for decoding subsequently processed video content) of a first format is serialized with a memory allocation for decoder buffers of a second format. That is, the allocation of new memory for new decoder buffers associated with a new format is conditioned upon the release of previously-allocated memory for decoder buffers associated with a previous format. For example, a decoder driver can program a hardware decoder of the computing device to determine that a last encoded video frame of a first format has been decoded into a last decoded video frame of the first format (i.e., the video content of the first format is finished decoding), and in response, previously-allocated memory for first decoder buffers used in decoding the video content of the first format can be released, and new memory for second decoder buffers to be used in decoding video content of the second format can be subsequently allocated. In this manner, release of previously-allocated memory for decoder buffers of the first format is serialized with the allocation of new memory for decoder buffers of the second format so that the respective memory allocations do not coexist and undesirably increase memory usage during the format change. Instead, the amount of in-use memory of a computing device is reduced during a format transition period by releasing a first memory allocation for first decoder buffers of a first format prior to allocating second memory for second decoder buffers of a second format.

The techniques and systems described herein provide a decoder that reduces memory usage of an associated computing device in one or more respects when decoding media content during a format change, as compared to the amount of memory used by current decoders under the same conditions. The reduction in memory usage frees up more resources, making these resources available for other processes and applications of the computing device to operate faster and more efficiently.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 is a schematic diagram of an example architecture including an example computing device configured to decode media content according to the techniques described herein.

FIG. 2 is a schematic diagram showing an example technique of sequencing discretized memory allocations and release operations for output buffers during a format change.

FIG. 3 is a schematic diagram showing an example technique of serializing memory release operations and allocations for decoder buffers during a format change.

FIG. 4 is a flow diagram of an example process for sequencing discretized memory allocations and release operations for output buffers during a format change.

FIG. 5 is a flow diagram of an example process for serializing memory release operations and allocations for decoder buffers during a format change.

FIG. 6 is a schematic diagram of a computer architecture for a computing device configured to decode media content according to the techniques described herein.

### DETAILED DESCRIPTION

Configurations of the present disclosure are directed to, among other things, techniques and systems for reducing memory usage by a decoder during a format change from a first format to a second, different format. For illustrative purposes, media content is often described herein as video content, and the examples presented herein are often described in terms of video content that is “streamed,” or received over a network by a playback device that can receive media content via the network. However, it is to be appreciated that the configurations disclosed herein can be implemented in a number of ways and in varying applications. For example, the techniques described herein can be utilized for an audio decoder that decodes audio content. Although audio content is generally less memory intensive to decode than video content, in a severely memory-constrained client device (e.g., a small wearable computer, such as a hearing aid), the memory-constrained computing device can benefit from the memory-reduction techniques described herein, even when exclusively decoding audio content.

Additionally, the techniques and systems can be utilized in situations where media content is accessed from a local media source, such as, without limitation, a hard disk drive (HDD), a solid state drive (SSD), or some other type of digital video recorder (DVR) integrated with the computing device, or a removable storage device, such as a digital versatile disc (DVD), a Blu-ray disc, a thumb drive, and so on. Thus, the techniques and systems described herein are not limited to streaming or broadcast media scenarios. Additionally, the media content can represent any type of playable content, such as movies, television programs, music, live video streams for video conferencing, games, software programs, and so on.

### Example Architecture

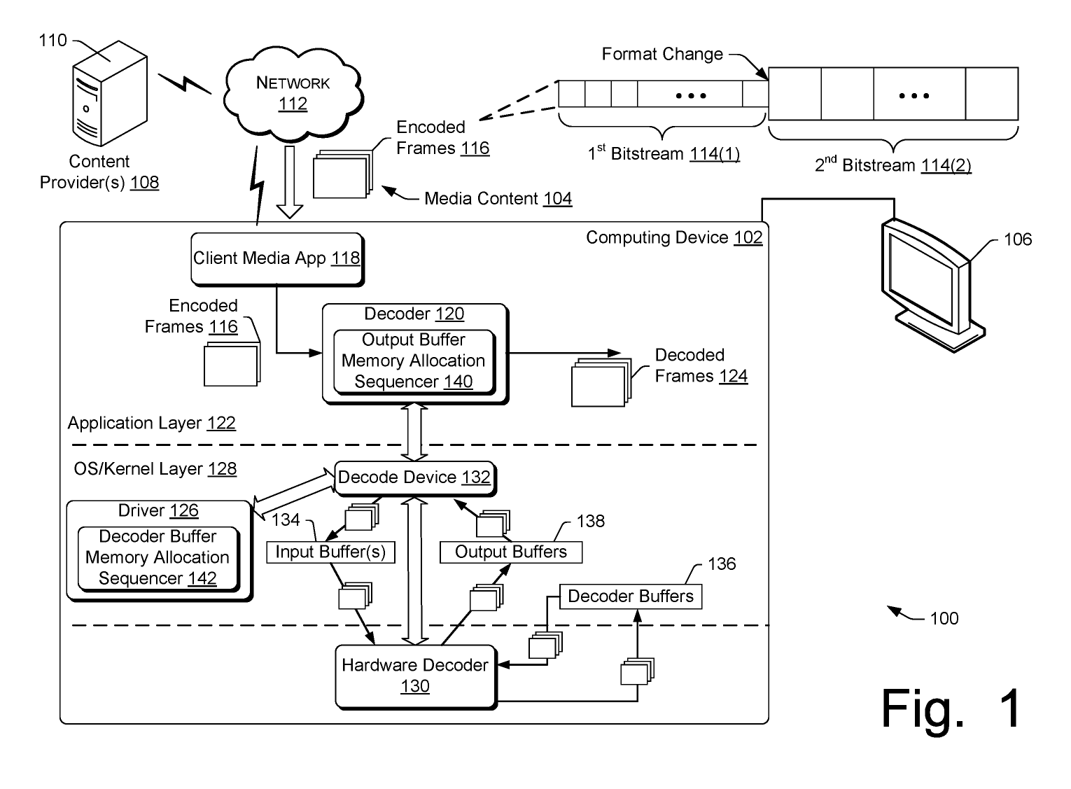

FIG. 1 is a schematic diagram of an example architecture 100 including an example computing device 102 configured to decode media content 104. The architecture 100 is merely one example, and the techniques described herein are not limited to performance using the architecture 100 of FIG. 1.

The computing device 102 (sometimes referred to as a “client computing device 102,” “client device 102,” “playback device 102,” or “consumer device 102”) can be implemented as any type of computing device 102 including, but not limited to, a game console, a set-top box (STB), a smart television (TV), a media streaming player, a personal computer, a laptop computer, a tablet computer, a portable digital assistant (PDA), a mobile phone (e.g., a smart phone), an electronic book (e-book) reader, a portable game player, a portable media player, a wearable computer (e.g., a smart watch, smart glasses, etc.), and so forth.

The computing device 102 can be configured to receive encoded media content 104 and to output decoded media content 104 on an output device 106. The output device 106 can comprise a display on which video content is presented. The output device 106 can be integral to (i.e., embedded in) the computing device 102, such as a display integral to a smart phone, or the output device 106 can comprise a peripheral output device coupled to the computing device 102, such as a display that is coupled (via wired or wireless means) to a game console. The output device 106 can include speakers or similar components for outputting audio content.

The media content 104 can be received from any suitable content source. For example, remote sources, such as content provider(s) 108, can provide the media content 104. The content provider(s) 108 can include, without limitation, service providers of streaming or downloadable video content (e.g., Netflix®, YouTube®, Hulu®, Facebook®, Twitter®, etc.), service providers of broadcast television (e.g., cable operators, satellite operators, etc.), and so on. The content provider(s) 108 can be associated with one or more server computing devices 110 (or “server(s) 110”) that broadcast, or transmit upon request, the media content 104 to the client computing device 102 over a network 112. The network 112 can represent any one or combination of multiple different types of wired and/or wireless networks, such as cable networks, the Internet, local area networks, mobile telephone networks, wide area networks, or a combination of such networks. Alternatively, the media content 104 can be retrieved from local sources, such as a HDD, a SSD, or another type of DVR of the computing device 102, or from removable storage (e.g., a DVD, a Blu-Ray disc, a thumb drive, etc.).

The media content 104 can be received at, or accessed by, the computing device 102 as one or more bitstreams. As used herein, “receiving a bitstream” can comprise receiving a bitstream over the network 112 from a remote content provider(s) 108, or accessing the bitstream from a local media source of the computing device 102. FIG. 1 shows a first bitstream 114(1) and a second bitstream 114(2) that carries the media content 104. The first bitstream 114(1) carries a first portion of the media content 104 encoded in a first format, and the second bitstream 114(2) carries a second portion of the media content 104 encoded in a second format that is different than the first format. When the two bitstreams 114(1) and 114(2) are received and processed in sequence, the processing of the media content 104 involves a format change (i.e., a transition from decoding in the first format to decoding in the second format) upon receiving the second bitstream 114(2) at the computing device 102 after receipt of the first bitstream 114(1). There are several potential reasons for providing media content 104 in at least two different formats, sequentially.

One example reason for providing media content 104 in at least two different formats, sequentially, is to provide a better streaming experience for an end user. For example, the server(s) 110 can initially provide the first bitstream 114(1) with the media content 104 encoded in a resolution of 1280×720 pixels. The first bitstream 114(1)—being encoded in a relatively lower resolution and lower bitrate than the resolution and the bitrate of a to-be-provided second bitstream 114(2)—can be transmitted over the network 112 faster and processed by the computing device 102 quickly so that the media content 104 fills an input buffer in a relatively short time, thereby reducing a time to start-up of the media playback to a period that is unnoticeable, or at least tolerable, to the end user. Thus, the computing device 102 sacrifices quality of the media content 104 in order to output the media content 104 at a faster speed on the output device 106. After the computing device 102 begins playback of the media content 104 in the first bitstream 114(1) (or after a predetermined time period that is known to provide a sufficient amount of the media content 104 in the first bitstream 114(1)), the computing device 102 starts receiving the second bitstream 114(2) with a subsequent portion of the media content 104 encoded at a higher resolution format with higher bitrate (e.g., 1920×1080 pixels). In this scenario, playback of the media content 104 in the first bitstream 114(1) begins prior to, and continues during, receipt and decoding of the subsequent portion of the media content 104 in the second bitstream 114(1), and ultimately, the computing device 102 outputs the media content 104 at the higher resolution and higher bitrate (i.e., higher quality).

Another potential reason for providing the media content 104 in at least two different formats, sequentially, is due to worsening network conditions. For example, if, while streaming the media content 104, the network bandwidth significantly degrades (e.g., due to a high demand placed on the network 112 from hundreds or thousands of computing devices accessing data over the network 112), the server(s) 110 can be configured to dynamically adjust the format of the media content 104 by transitioning from providing a first bitstream 114(1) with media content 104 encoded in a high resolution and high bitrate format to a second bitstream 114(2) with media content 104 encoded in a lower resolution and lower bitrate format. The adjustment to the lower resolution and lower bitrate format of the second bitstream 114(2) ensures that the computing device 102 can receive the media content 104 fast enough to avoid adverse effects (e.g., freezing video, lagging video, etc.) in the media playback.

Another potential reason that the media content 104 goes through a format change is with media content 104 played from an optical disc (e.g., a Blu-ray disc), where the previews (or commercials) of the media content 104 can be encoded in a lower resolution and lower bitrate format than the resolution and bitrate used for encoding the main media content 104 (e.g., the movie). Thus, there are several possible scenarios where a format change can occur in the process of decoding and outputting media content 104.

Although the format change is often described herein in terms of a change in resolution (e.g., transitioning from 1280×720 pixels to 1920×1080 pixels), other types of format changes are contemplated herein, such as, without limitation, a change in bitrate, a change from one codec (e.g., H.264) to another codec (e.g., MPEG-2), or a change from one encoding profile/level to another encoding profile/level, and so on. As used herein, a “format change” can cover any of the aforementioned types of format changes or any similar format change scenario to those described herein.

In some configurations, the first bitstream 114(1) and the second bitstream 114(2) can carry the media content 104 in the form of multiple encoded frames 116, such as encoded video frames. Such encoded frames 116 can comprise pictures (or still images) that, when decoded and played at a high frame rate, result in playback of video content. The frames 116 in the first bitstream 114(1) are encoded in a first format, and the frames 116 in the second bitstream 114(2) are encoded in a second, different (e.g., higher or lower resolution and bitrate) format.

The computing device 102 can include a client media application 118 configured to download and/or stream the media content 104 over the network 112, and/or access locally-stored media content 104, as well as cause the media content 104 to be played back on the output device 106. The client media application 118 can comprise a media player, such as a video player, an audio player, or any similar media playback application. In some configurations, the client media application 118 can comprise a Web browser that accesses the media content 104 from a website provided by the content provider(s) 108. In some configurations, the client computing device 102 can download the client media application 118 (e.g., from an “app store”) over the network 112. In other configurations, the client media application 118 can be a stock media playback application provided on the computing device 102 at the time of the computing device's 102 manufacture. The client media application 118 can be stored in memory of the computing device 102 and executed on the computing device 102 to playback the media content 104.

The client media application 118 can be invoked in response to user input from a user of the computing device 102, and upon receiving the encoded media content 104 (e.g., the encoded frames 116), the client media application 118 can invoke (i.e., call into) a decoder 120 provided in an application layer 122 of the computing device 102. The decoder 120 can be provided by the operating system (OS) of the computing device 102, and can include, for example, a Media Foundation Transform (MFT), which is a generic model for processing media data. The decoder 120 is configured to control the overall decoding operations involved in decoding the media content 104. The decoder 120 is configured to transform the encoded media content 104 (e.g., the encoded frames 116) into decoded media content 104 (e.g., multiple decoded frames 124) that are ultimately output via the output device 106. In some configurations the decoder 120 is configured to transform compressed media content 104 into uncompressed media content 104 that is suitable for rendering via the output device 106. In an example, the decoder 120 comprises a video decoder that outputs the decoded frames 124 in the form of YUV video frames, RGB video frames, or any similar type of decoded video frame that corresponds to the media content 104 in the compressed, encoded frame 116. Furthermore, the decoder 120 can decode according to any suitable codec or decoding standard, such as Windows Media Video or VC-1 standard, MPEG-x standard (e.g., MPEG-1, MPEG-2, or MPEG-4), H.26x standard (e.g., H.261, H.262, H.263, or H.264), VP8/VP9/WebM standard, or any other suitable codec/standard.

The decoder 120 is configured to send and receive data to and from a driver 126 in the OS/kernel layer 128 of the computing device 102 for decoding purposes. The driver 126 can comprise any suitable driver component, such as a DirectX driver, a Windows Display Driver Model (WDDM), or any similar driver 126. Components in the OS/kernel layer 128 are generally permitted to execute the full instruction set of a central processing unit (CPU) of the computing device 102, access all parts of the computing device's 102 memory, and interact directly with hardware components, such as a hardware decoder 130, of the computing device 102.

Upon receipt of the first bitstream 114(1), the decoder 120 can create, or instantiate, a decode device 132, which is a software class that allows the decoder 120 to send control information (e.g., picture parameters, macroblock parameters, etc.) and other information to the driver 126 for access and use by an accelerator (e.g., the hardware decoder 130) across an acceleration interface. Accordingly, memory of the computing device 102 is allocated for storing the instantiated decode device 132 so that the decode device 132 can receive and maintain decoding instructions and information from the decoder 120, which can then be made available to the driver 126 in order to implement decoding operations based on the instructions and information provided by the decoder 120.

In some configurations, the decoder 120 is configured to use acceleration to offload computationally intensive operations to the hardware decoder 130. Accordingly, the decode device 132 can comprise a DirectX video acceleration (DXVA) decode device 132, and the hardware decoder 130 can comprise a graphics processing unit (GPU) or a similar hardware component configured to enable acceleration (e.g., video acceleration) by the hardware decoder 130 processing and decoding media content 104 (e.g., video content) received via buffers created by the decode device 132. The decode device 132 can specify a set of operations that can be hardware accelerated, as well as enable device driver interfaces that a graphics driver of the hardware decoder 130 can implement to accelerate decoding operations.

As noted above, the decode device 132 instantiated by the decoder 120, can also be used to allocate memory for various buffers used in decoding and rendering received media content 104. For example, the decode device 132 can allocate memory for an input buffer(s) 134 for maintaining the multiple encoded frames 116 of a received bitstream. The size and number of input buffers 134, and hence, the amount of memory allocated for the input buffer(s) 134, depends on the implementation. In some configurations, the memory allocated for the input buffer(s) 134 can be on the order of several megabytes (MB), which is often sufficient to temporarily store compressed/encoded video content. For example, upon receipt of the first bitstream 114(1), the decode device 132 allocates memory for the input buffer(s) 134 (as well as the additional buffers described below), and the decoder 120 writes the multiple encoded frames 116 received in the first bitstream 114(1) to the input buffer(s) 134.

The decode device 132 can further allocate memory for multiple decoder buffers 136. In some configurations the decoder buffers 136 can comprise multiple decoded picture buffers (DPBs). In general, the decoder buffers 136 (e.g., DPBs) comprise internal decoder buffers that are used for maintaining information relating to decoded frames 124, and/or the decoded frames 124 themselves, for use in decoding other, subsequently-received encoded frames 116. For example, the decoder buffers 136 can store decoded reference frames. The decoder buffers 136 can be used for motion compensation, performing inverse discrete cosine transform (IDCT) operations, or any combination thereof, that is useful in decoding media content 104, such as video content. In some configurations, the decoder buffers 136 store reconstructed image plane information derived from previously-decoded video frames, such as luma and chroma values, side information, reference index information, slice identifier information, mode information, partition information, and so on. In some configurations, the decoder buffers 136 store information such as motion vectors, block partitions, frequency coefficients, output of an entropy decoder, etc. The size and number of decoder buffers 136, and hence, the amount of memory allocated for the decoder buffers 136, depends on the implementation. In some configurations, memory can be allocated for “M” decoder buffers 136, M being a number (e.g., 5) of decoder buffers 136 that provides a minimum amount of memory for decoding a frame 116 of an incoming bitstream. Thus, the number “M” can be based at least in part on parameters of the bitstream being decoded, such as the first bitstream 114(1). For example, depending on the format used to encode the media content 104 in the first bitstream 114(1), the number “M” of decoder buffers 136 can be higher or lower to accommodate a higher or lower resolution and lower bitrate format.

The decode device 132 can further allocate memory for multiple output buffers 138 (sometimes referred to as “display buffers 138”). The output buffers 138 can be used for maintaining decoded media content that is to be output on the output device 106. For example, the output buffers 138 can maintain decoded video frames 124 until the decoded video frames 124 are rendered on a display of the output device 106. Accordingly, the decoded frames 124 are written to, and maintained in, the output buffers 138 until the client media application 118 retrieves the decoded frames 124 for rendering on the output device 106. In some implementations, a first memory allocation for the output buffers 138 can be maintained separately from a second memory allocation for and the decoded frames 124, while in other implementations the same memory allocation can be shared for the output buffers 138 and the decoded frames 124. In some implementations, the decoded frames 124 can point to the output buffers 138 allocated by decode devices, such as the decode device 132. The size and number of output buffers 138, and hence, the amount of memory allocated for the output buffers 138, depends on the implementation. In some configurations, memory can be allocated for “N” output buffers 138, N being a number that is greater than M (corresponding to the number of decoder buffers 136). The number (N) of output buffers 138 can depend on parameters of the bitstream being decoded, such as the first bitstream 114(1). In an example, the number “N” can also depend on the size or number (M) of the decoder buffers 136. In some configurations, the client media application 118 can specify an additional buffer size for, or an additional number of, the output buffers 138 that is to be added to the number (M), or size, of the decoder buffers 136 to generate the N output buffers 138. For example, the client media application 118 can specify that the number (N) of output buffers 138 is to include 5 additional buffers to the number (M) of decoder buffers 136. In this example, if M=5 (i.e., 5 decoder buffers 136 are created), then N=10 (i.e., 10 output buffers 138 are created). The extra size or number of the output buffers 138 allows the system to handle network jitters and/or other foreseeable issues that can arise in the process of decoding media content 104.

The output buffers 138 can be shared between the driver 126 and the client media application 118 such that the decoded frames 124 can be written to the output buffers 138 in the OS/kernel layer 128, and accessed for rendering in the application layer 122. Upon rendering a decoded frame 124 on the output device 106 (e.g., a display), a deletion command can be issued that causes deletion of the decoded frame 124 from the output buffers 138. When all decoded frames 124 are deleted from a particular output buffer 138, and there are no more decoded frames 124 to be written to the output buffer 138, the discretized memory allocated for the particular output buffer 138 can be released, as will be described in more detail below.

An individual buffer, such as individual ones of the input buffer(s) 134, the decoder buffers 136, and the output buffers 138, can represent an area of contiguous memory of the computing device 102 allocated for that buffer. The area of contiguous memory for the buffer can have a start address referenced with a pointer, a maximum length, and a current length. When memory is allocated for an individual buffer, the buffer's maximum length can be specified, and a pointer to the buffer can be returned. As used herein, the term “allocate” can refer to the allotment of an available portion of memory of the computing device 102 for a newly-created buffer, program, or data structure (e.g., the decode device 132). Allocated memory can be “released,” which reverses the previous allocation and frees the memory, making it available to other processes, applications, and/or devices. Thus, memory can be allocated for one or more of the buffers described herein, and when the allocated memory is released, the buffer is also removed (or deleted). To write to the buffer, an application can obtain a lock on the buffer with a pointer to its memory address and its maximum length, write data to the buffer, set the current length for the data that was written to the buffer, and unlock the buffer for use by other applications or processes. After data is written to the buffer, the current length for the data corresponds to “in-use” memory, as the term is used herein. In other words, the memory can first be allocated, and then, when data is written to the buffer, the portion of the buffer (current length) that is occupied by the stored data is considered to be “in-use” memory, or memory that is being used or otherwise consumed. To read from the buffer, an application can obtain a lock on the buffer with a pointer to its memory address and its maximum length, read data from the buffer, and unlock the buffer for use by other applications or processes.

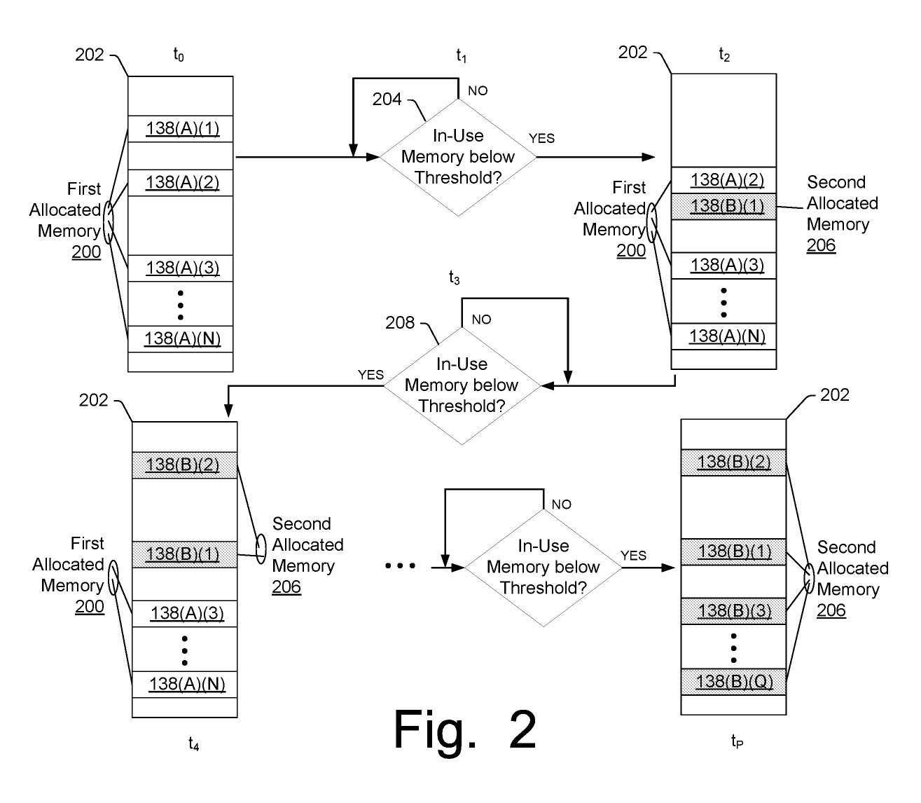

FIG. 1 shows that the decoder 120 includes an output buffer memory allocation sequencer 140 (abbreviated hereafter as “output buffer sequencer 140”). The output buffer sequencer 140 is configured to sequence discretized memory allocations with discretized release operations for two different formats during a format change. In order to describe the operations performed by the output buffer sequencer 140, reference is made to FIG. 2.

FIG. 2 is a schematic diagram showing an example technique of sequencing discretized memory allocations and release operations for output buffers 138 during a format change. The techniques shown in FIG. 2 can be implemented by the output buffer sequencer 140 of FIG. 1 in order to reduce memory usage during a format change.

Initially, at time, to, the first bitstream 114(1) is received at the computing device 102 (the first bitstream 114(1) having first encoded media content 104 (e.g., multiple first encoded frames 116) encoded in a first format). Upon receipt of the first bitstream 114(1), first memory 200—which is a subset of overall/absolute memory 202 of the computing device 102—is allocated for the decoding resources that are to be used in decoding the first encoded media content 104 of the first bitstream 114(1). For example, the first allocated memory 200 can include a discretized memory allocation for a first decode device 132 instantiated by the decoder 120, a discretized memory allocation for each input buffer(s) 134, each decoder buffers 136, and each output buffers 138. FIG. 2, at time, to, shows the discretized memory allocations for a set of first output buffers first output buffers 138(A)(1), 138(A)(2), 138(A)(3), . . . , 138(A)(N), which make up N first output buffers 138 that are to be used for maintaining first decoded media content 104 (e.g., first decoded frames 124) of the first bitstream 114(1).

As shown in FIG. 2, the first allocated memory 200 can be broken-down (i.e., discretized) into independently-allocated portions of the first allocated memory 200 so long as the driver 126 supports non-texture arrays for the memory allocation of the output buffers 138. That is, rather than allocating a single, contiguous portion of the memory 202 for all of the N first output buffers 138(A), where the single, contiguous portion would be allocated and released as a whole, the driver 126 that supports non-texture arrays enables the decode device 132 to independently allocate a first discretized portion of the first allocated memory 200 that corresponds to the first output buffer 138(A)(1), a second discretized portion of the first allocated memory 200 that corresponds to the second output buffer 138(A)(2), and so on for remaining ones of the N output buffers 138. Despite the ability to allocate and release the discrete portions of the first allocated memory 200 independently, the decode device 132, at time, to, can allocate the full extent of the first memory 200 in a single process call (i.e., create all of the N first output buffers 138(A) in a single process call) because there is no previous bitstream being decoded prior to receipt of the first bitstream 114(1).

At a later time, ti, a portion of the media content 104 in the first bitstream 114(1) has been decoded and rendered on the output device 106, and the second bitstream 114(2) has been received at the computing device 102. In response to receipt of the second bitstream 114(2), the output buffer sequencer 140 perform a check, shown by decision block 204, to determine whether an amount of in-use memory of the computing device 102 is less than a threshold amount of in-use memory. This threshold amount can be format-specific since memory used for decoding can vary across different formats. In this example, the threshold amount monitored at 204 can be associated with the first format of the first bitstream 114(1). In other words, when transitioning from a first format of the first bitstream 114(1) to a second format of the second bitstream 114(2), the threshold amount monitored at 204 can be, for example, a predetermined amount of the first allocated memory 200 that is selected based on the first format, a predetermined amount of the absolute memory 202 of the computing device 102 that is selected based on the first format, a predetermined number of the decoded frames 124 that is selected based on the first format, a predetermined number of the output buffers 138 that is selected based on the first format, and so on. In some configurations, this can be implemented based on a lookup table or a similar data structure that includes one or more thresholds that correspond to different formats. For example, the threshold amount monitored at 204 can be determined by referencing a lookup table and identifying the threshold amount corresponding to the first format. As another example, when transitioning from a second format to a third format, the threshold amount monitored at 204 can be determined by referencing a lookup table and identifying the threshold amount corresponding to the second format, and so on. In some configurations, the threshold amount associated with a relatively lower resolution and/or bitrate format is lower as compared to a threshold amount associated with a relatively higher resolution and/or bitrate format. This can be due to the fact that, at a given time during decoding, the amount of in-use memory for a lower resolution and/or bitrate format is likely to be lower than the amount of in-use memory for a higher resolution and/or bitrate format at a correspondingly similar time during decoding of the higher resolution and/or bitrate format.

It is to be appreciated that the check performed at 204 may not be supported on all systems. In such cases, a decoder 120 can attempt to optimize the memory usage during decoding by using the other techniques described herein, along with a heuristic that informs the decoder 120 when to allocate new memory, a heuristic that informs the decoder 120 of the maximum memory usage by the client media application 116.

Eventually, as more of the decoded media content 104 of the first bitstream 114(1) is rendered on the output device 106, the decode device 132 can begin to release portions of the first allocated memory 200 that are no longer needed. For example, the decode device 132, after rendering a last decoded frame 124 in the first output buffer 138(A)(1) and deleting the last decoded frame 124 from the first output buffer 138(A)(1), can release the portion of the first allocated memory 200 corresponding to the first output buffer 138(A)(1), assuming there are no remaining decoded frames 124 to be written to the first output buffer 138(A)(1) and none of the decoded frames 124 in the first output buffer 138(A)(1) are to be referenced for decoding other frames in the first bitstream 114(1). After this discretized portion of the first memory 200 is released, the remainder of the first memory 200 remains allocated for the remaining first output buffers 138(A)(2)-(N) that still hold decoded frames 124 to be output on the output device 106.

In response to releasing the discretized portion of the first memory 200 allocated for the first output buffer 138(A)(1), the amount of in-use memory of the computing device 102 decreases. Accordingly, prior to the release of this discretized portion of the first allocated memory 200, the result of the decision at 204 can follow the “No” route and continue monitoring the amount of in-use memory against the threshold amount. However, in response to the release of this discretized portion of the first allocated memory 200, the amount of in-use memory can drop below the threshold amount, and the output buffer sequencer 140, in response to this indication, can follow the “Yes” route from 204 to allocate second memory 206 for a second output buffer 138(B)(1) associated with the second bitstream 114(2).

Thus, at time, t₂, the second memory 206 is shown as a discretized memory allocation that is allocated for the individual second output buffer 138(B)(1), which represents one of multiple second output buffers 138(B) that are to be created for decoding and rendering the media content 104 of the second bitstream 114(2) associated with the second format. In other words, instead of allocating an entire working set of second memory for a total number (Q) of second output buffers 138(B) to be created for the second bitstream 114(2) in a single process call, the output buffer sequencer 140 is configured to wait until sufficient memory is available (e.g., wait for a portion of the first allocated memory 200 to be released), and in response, allocate a discretized portion of the full memory allotment for the second output buffers 138(B) in a process call, and then incrementally allocate additional discretized portions of the full memory allotment for additional second output buffers 138(B) in response to subsequently-received indications that the amount of the in-use memory drops, or remains, below the threshold amount. This staggering of memory allocations for the second output buffers 138(B) of the second bitstream 114(2) reduces the memory usage during a format change from the first format to a second format. As the output buffer sequencer 140 continues allocating memory for the second output buffers 138(B), the output buffer sequencer 140 continues decoding frames from the second bitstream 114(2) and writing the decoded frames 124 into those second output buffers 138(B). In some configurations, the decoder 120 does not wait for the full memory allotment for all of the second output buffers 138(B) to be allocated before starting the decoding of the encoded frames 116 of the second bitstream 114(2).

In some configurations, the second output buffer 138(B)(1) created at time, t₂ , corresponds to a first-created second output buffer 138(B) of a total number (Q) of second output buffers 138(B) to be created for the second bitstream 114(2). In other configurations, the second output buffer 138(B)(1) can be created after some amount of the second memory 206 has already been allocated for one or more second output buffers 138(B) for the second bitstream 114(2). For example, in response to receipt of the second bitstream 114(2) and prior to performing the check at 204, the decode device 132 can initially allocate a portion of the second memory 206 for a number (M) of the second output buffers 138(B) for the second bitstream 114(2) that is less than the total number (Q) of second output buffers 138(B) to be created for the second bitstream 114(2). After this initial memory allocation for the M second output buffers 138(B), the output buffer sequencer 140 can perform the check at 204 and subsequently stagger additional discretized memory allocations for subsequent second output buffers 138(B) for the second bitstream 114(2).

In some configurations, the decision at 204 can also include a check to see if a previous bitstream (such as the first bitstream 114(1)) has been received prior to the second bitstream 114(2). In other words, the output buffer sequencer 140 can be configured to perform a check that the second bitstream 114(2) is in fact a “second” or subsequently received bitstream, rather than the first bitstream 114(1). Furthermore, the check at 204 can be implemented as a “polling” function of the output buffer sequencer 140 to affirmatively request (i.e., poll for) the amount of in-use memory to be monitored at 204. Polling can be issued periodically or in response to an interrupt or another trigger. In other configurations, the check at 204 can be implemented as a push notification received at the output buffer sequencer 140 that provides the indication of the amount of in-use memory to the output buffer sequencer 140. This push notification can be issued in response to an event, such as in response to the rendering, and/or the subsequent deletion of, a decoded frame 124 of the first bitstream 114(1), or in response to the amount of in-use memory dropping from an amount at or above the threshold amount to an amount below the threshold amount.

The decision at 204 can be implemented in a number of ways. For example, at 204, the output buffer sequencer 140 can receive an indication that a portion of the first allocated memory 200 is released, indicating that an amount of in-use memory is below a threshold amount. In this scenario, the threshold amount can be set at the amount of memory used by the N first output buffers 138(A) maintaining the decoded media content 104 of the first bitstream 114(1)).

As another example, at 204, the output buffer sequencer 140 can receive an indication that a remaining in-use portion of the first allocated memory 200 is below a threshold amount. For example, the threshold amount can be set at an amount that is less than the memory used by the N first output buffers 138(A) maintaining the decoded media content 104, and as soon as a portion of the first memory 200 is released and the amount of in-use memory used by the remaining portion of the first allocated memory 200 drops below the threshold amount, the decision at 204 follows the “Yes” route.

As another example, at 204, the output buffer sequencer 140 can receive an indication that an absolute (or overall) amount of in-use memory of the computing device 102 is below a threshold amount. By monitoring an “absolute” amount of in-use memory of the computing device 102, as opposed to an amount of in-use memory that is specific to memory used for decoding operations, the output buffer sequencer 140 can monitor the absolute amount of in-use memory against an absolute in-use memory threshold (e.g., 300 MB). In this way, the output buffer sequencer 140 can adapt to various scenarios that are outside the control of the decoder 120, such as when another process or application (e.g., a network process) is using a disproportionately high amount of the computing device's 102 memory. In such a scenario, the output buffer sequencer 140 can determine that the absolute amount of in-use memory is too high (i.e., above the threshold), and can wait to allocate the second memory 206 for the second output buffer 138(B)(1) until the absolute in-use memory drops below the threshold amount. In this manner, the decision at 204 can be tied to non-decoding processes and applications that may be executing on the computing device 102 and consuming memory resources. In some configurations, comparing the absolute amount of in-use memory of the computing device 102 can be an additional determination that is made in addition to determining whether the remaining in-use memory of the first memory 200 is below a threshold based on the first format. For example, the check at 204 may involve first determining that the remaining amount of in-use memory of the first memory 200 is below a format-specific threshold for the first format, and if so, perform an additional check to see if the absolute amount of in-use memory of the computing device 102 is below an additional absolute in-use memory threshold. If a non-decoding process is using a disproportionately high amount of memory, this additional check may result in the output buffer sequencer 140 waiting until the absolute in-use memory falls below the additional threshold, or otherwise waiting for both checks to pass before allocating the second memory 206 for the second output buffer 138(B)(1).

As another example, at 204, the output buffer sequencer 140 can receive an indication that a number of decoded frames 124 that have not been output to the output device 106 is less than a threshold number. The number of “to-be-output” (e.g., to-be-rendered) frames of the decoded frames 124 that remain in the pipeline can be translated to an amount of in-use memory, or can be taken as an indication of an amount of in-use memory associated with those frames. For example, assume, during playback of the media content 104, that 9 decoded frames 124 of the first bitstream 114(1) remain in the first output buffers 138(A) and have not yet been rendered. If the threshold number of frames is set at 10 frames, then the check at 204 determines that 9 is less than 10 and follows the “Yes” route to allocate the second memory 206 for the second output buffer 138(B)(1). Following the creation of the second output buffer 138(B)(1), an encoded frame 116 of the second bitstream 114(2) can be decoded, and the resulting decoded frame 124 can be written to the second output buffer 138(B)(1).

As another example, at 204, the output buffer sequencer 140 can receive an indication that a number of the remaining first output buffers 138(A) of the first allocated memory 200 is less than a threshold number. The number of remaining first output buffers 138(A) can be translated to an amount of in-use memory, or can be taken as an indication of an amount of in-use memory associated with the remaining first output buffers 138(A).

As another example, at 204, the output buffer sequencer 140 can receive an indication that a predetermined number of the decoded frames 124 have been deleted from the first output buffers 138(A), thus indicating that an amount of in-use memory has dropped below a threshold amount. The predetermined number can be any suitable number (e.g., 1, 2, 3, etc.). As another example, at 204, the output buffer sequencer 140 can receive an indication that a predetermined number of the first output buffers 138(A) have been cleared, thus indicating that an amount of in-use memory has dropped below a threshold amount.

At time, t₃ , after allocating the second memory 206 for the second output buffer 138(B)(1) associated with the second bitstream 114(2), the output buffer sequencer 140 can perform another check, shown by decision block 208, relating to an amount of in-use memory of the computing device 102 in comparison to a threshold amount of in-use memory. The decision at 208 can be the same as, or at least similar to, the decision at 204. For example, the same threshold can be monitored at both 204 and 208, such as a threshold amount of in-use memory. Alternatively, different thresholds can be monitored with respect to each of the decisions 204 and 208. For example, if the decision at 204 monitors whether there are less than 10 decoded frames 124 of the first bitstream 114(1) to be rendered on the output device 106, the decision at 208 can monitor whether there are less than 9 decoded frames 124 of the first bitstream 114(1) to be rendered on the output device 106. As such, a threshold can decrease (e.g., decrement) as additional portions of the first memory 200 are released due to rendering of additional decoded frames 124 of the first bitstream 114(1).

As described above with respect to decision 204, if the amount of in-use memory is not below the threshold amount, the output buffer sequencer 140 can follow the “No” route to continue monitoring the amount of in-use memory at 208. If, however, the client media application 118 renders another decoded frame 124 of the first bitstream 114(1), and another discretized portion of the first allocated memory 200 is released, the amount of in-use memory can drop below the threshold at 208, and the output buffer sequencer 140, in response to this indication, follows the “Yes” route to allocate another discretized portion of the second memory 206 for an additional second output buffer 138(B)(2). As shown in FIG. 2 at time, t₄, the second allocated memory 206 now comprises discretized allocations corresponding to the second output buffer 138(B)(1) and the second output buffer 138(B)(2). Additionally, at time, t₄, the first allocated memory 200 is shown as having released another discretized portion of the first allocated memory 200 corresponding to the first output buffer 138(A)(2). The release of this additional discretized portion of the first memory 200 may have caused the decision at 208 to proceed down the “Yes” route, causing the output buffer sequencer 140 to allocate the additional discretized portion of the second memory 206.

The staggered memory allocation technique shown in FIG. 2 can continue until all of the discretized memory allocations have been released from the first allocated memory 200, and all of the discretized memory allocations have been made for the second allocated memory 206 so that ultimately, as shown at time, t_{P}, the entire working set of the second memory 206 is allocated for the total number (Q) of second output buffers 138(B) used for decoding and rendering of the second bitstream 114(2). The number (Q) of second output buffers 138(B) can be equal to the number (N) of the first output buffers 138(A), or Q can be a different number than N.

In some configurations, as a result of waiting at each decision 204, 208, etc., to allocate additional memory of the second allocated memory 206, the hardware decoder can throttle down its decoding operations for the encoded media content 104 of the second bitstream 114(2), which slows down the decoding of the second bitstream 114(2) until a sufficient number of second output buffers 138(B) are created for the decoded frames 124 of the second bitstream 114(2). This throttling of the decoding operations for the second bitstream 114(2) can decrease the time period from the decoding of a frame to the output of the frame on the output device 106. However, a sufficiently-fast hardware decoder 130 can still decode the encoded media content 104 of the second bitstream 114(2) before the second output buffers 138(B) run out of decoded frames 124 for rendering on the output device 106.

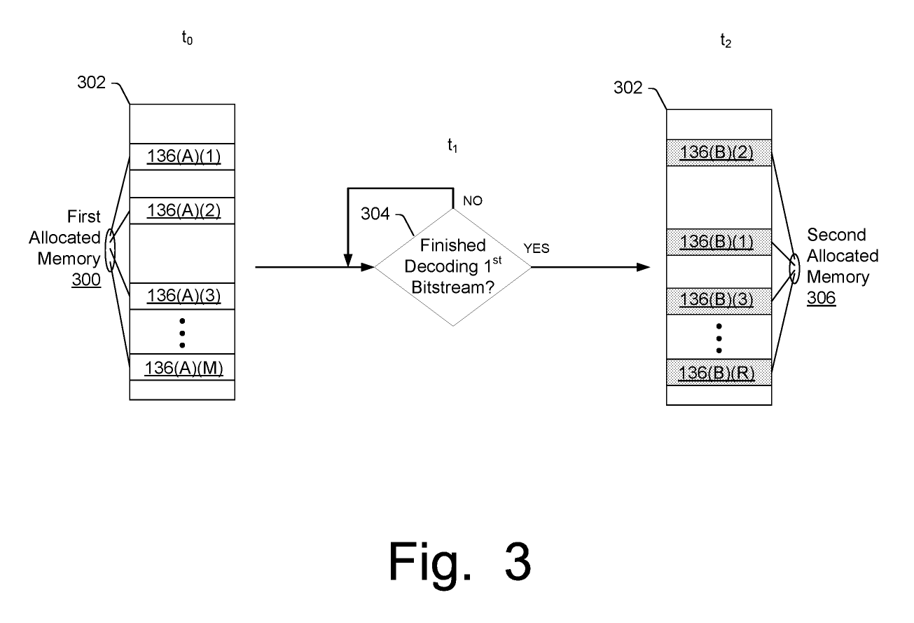

Returning to FIG. 1, the driver 126 is shown as including a decoder buffer memory allocation sequencer 142 (abbreviated hereafter as “decoder buffer sequencer 142”). The decoder buffer sequencer 142 is configured to serialize the release of previously-allocated memory for first decoder buffers 136 associated with the first format of the first bitstream 114(1) with the allocation of new memory for second decoder buffers 136 associated with the second format of the second bitstream 114(2) during a transition from a first format to a second, different format. Example operations implemented by the decoder buffer sequencer 142 are described with reference to FIG. 3, which shows a schematic diagram of an example technique of serializing memory releases and allocations for decoder buffers 136 during a format change.

As shown in FIG. 3, at time, to, the first bitstream 114(1) is received at the computing device 102 (the first bitstream 114(1) having first encoded media content 104 (e.g., multiple first encoded frames 116) encoded in a first format). In response to receipt of the first bitstream 114(1), first memory 300—which is a subset of overall (or absolute) memory 302 of the computing device 102—is allocated for the decoding resources that are to be used in decoding the first encoded media content 104 of the first bitstream 114(1). For example, the first allocated memory 300 can include a discretized memory allocation for a decode device 132 instantiated by the decoder 120, a discretized memory allocation for each first input buffer(s) 134, each first decoder buffers 136, and each first output buffers 138. FIG. 3 shows the multiple first decoder buffers 136(A)(1), 136(A)(2), 136(A)(3), . . . , 136(A)(M), which make up M first decoder buffers 136 (e.g., DPBs). Each decoder buffer 136(A) can comprise an internal decoder buffer that is used for maintaining information relating to decoded frames 124, and/or the decoded frames 124 themselves, for use in decoding other, subsequently-received encoded frames 116 of the first bitstream 114(1).

The decode device 132 that is instantiated by the decoder 120 can be “agnostic” to the format of the incoming first bitstream 114(1) such that the decode device 132 instantiated for the first bitstream 114(1) can be re-used for decoding the second bitstream 114(2). This is different from today's decode devices, which are instantiated for each format such that a new decode device 132 would be created for the second bitstream 114(2). Using a format-agnostic decode device 132 relies on a hardware decoder 130 that can support a format change internally, which most newer hardware decoder can support. Accordingly, the hardware decoder 130 can be configured to transition from decoding the first encoded media content 104 of the first bitstream 114(1) to decoding the second encoded media content 104 of the second bitstream 114(2) on-the-fly (meaning that the hardware decoder 130 does not require a new decode device 132 to be instantiated for the second bitstream 114(2) in order to decode the media content 104 of the second bitstream 114(2)). Instead, the same decode device 132 can be re-used across format changes. Furthermore, in response to receiving the first bitstream 114(1), the driver 126 can issue an application programming interface (API) call to obtain the capabilities of the hardware decoder 130, thereby informing the host decoder 120 whether the hardware decoder 130 can support a format change internally to carry out the techniques shown in FIG. 3.

At a later time, t₁, when a substantial portion of the media content 104 in the first bitstream 114(1) has been decoded and output on the output device 106, and the second bitstream 114(2) has been received at the computing device 102, the decoder buffer sequencer 142 can perform a check, shown by decision block 304, to determine whether the media content 104 of the first format is finished decoding. The determination at 304 can include a determination that a last encoded frame 116 of the encoded frames 116 of the first bitstream 114(1) has been decoded into a last decoded frame 124 of the decoded frames 124 of the first bitstream 114(1).

If it is determined at 304 that the first bitstream 114(1) has not finished decoding, the decoder buffer sequencer 142 can follow the “No” route to continue monitoring the status of the decoding of the first bitstream 114(1). If the decoder buffer sequencer 142 determines, at 304, that the first bitstream 114(1) has finished decoding, the decoder buffer sequencer 142 cause the first allocated memory 300 to be released. The release of the first allocated memory 300 can be performed via a single process call notwithstanding the fact that the first memory 300 can be allocated as discretized portions that correspond to individual first decoder buffers 136(A), similar to the discretized memory allocation described with reference to FIG. 2.

Following the “Yes” route from 304 and the release of the first allocated memory 300, the hardware decoder 130 can be programmed (on-the-fly) to decode the media content 104 of the second bitstream 114(2) using the same decode device 132 that was instantiated for the first bitstream 114(1), and at time, t₂, the decoder buffer sequencer 142 can allocate second memory 306 for multiple second decoder buffers 136(B) to be used in decoding the encoded media content 104 of the second bitstream 114(2). FIG. 3 shows the multiple second decoder buffers 136(B)(1), 136(B)(2), 136(B)(3), . . . , 136(B)(R), which make up R second decoder buffers 136(B). The number (R) of second decoder buffers 136(B) can be equal to the number (M) of the first decoder buffers 136(A), or R can be a different number than M.

By serializing the release of the first memory 300 and the allocation of the second memory 306 (i.e., releasing the first memory 300 prior to allocating the second memory 306)—as opposed to releasing the first memory 300 after allocating the second memory 306—memory usage is reduced during the format change. Furthermore, by re-using a format-agnostic decode device 132, an overlap condition where two decode devices 132 coexist can be avoided, thereby reducing memory usage as compared to current decoding methods. The techniques described with reference to FIG. 3 for serializing the memory releases and allocations associated with the decoder buffers 136 represents an additional technique to that described with reference to FIG. 2, which described techniques for sequencing the memory allocations for the output buffers 138. The output buffer 138 sequencing technique of FIG. 2 can be performed independently of the decoder buffer 136 sequencing technique of FIG. 3, and vice versa. Alternatively, the two techniques can be combined, such that both techniques of FIGS. 2 and 3, respectively, optimize memory usage reduction during a format change.

Another memory usage reduction technique contemplated herein is to re-use or recycle buffers, such as some or all of the input buffer(s) 134, the decoder buffers 136, and the output buffers 138 used for decoding the media content 104 of the first bitstream 114(1) so that these buffers can be re-used without overlapping memory allocations for two sets of the same buffers. However, since different buffer sizes are used for decoding media content 104 encoded in different formats, one or more buffers used for decoding the media content 104 of a first format can be extended to a larger size buffer if the second format is, for example, a higher resolution and higher bitrate format than the resolution and bitrate of the first format, or the buffer(s) can be “shrunk” (or decreased in size) if the second format is, for example, a lower resolution and lower bitrate format than the resolution and bitrate of the first format. For example, a first output buffer 138(A) used for decoding and rendering media content 104 of the first bitstream 114(1) associated with a first format can be extended to a larger-size, second output buffer 138(B) to be used for decoding and rendering media content 104 of the second bitstream 114(2) associated with a second format. Extending a buffer can be conditioned upon the existence of free area of memory adjacent to the existing first output buffer 138(A) so that the first output buffer 138(A) can be extended to the second output buffer 138(B) that occupies a contiguous area of memory. In this manner, instead of allocating memory for respective decoding resources used for decoding media content 104 of two different formats simultaneously, the previous decoding resources (e.g., output buffers 138(A), decoder buffers 136(A), etc.) are extended or shrunk to accommodate a new format so that decoding resources are not doubled during a format change. Re-using or recycling decoding resources of a first format for use with a second format can require that decoding and rendering operations finish before the buffers are recycled. The hardware decoder 130, if able to decode the media content 104 of the second bitstream 114(2) fast enough, can avoid a glitch in the playback using this solution.

A similar, but slightly different option for reducing memory usage during a format change is to wait for the first decode device 132 and all of the first decoding resources (e.g., input buffer(s) 134, decoder buffers 136, output buffers 138) to finish decoding and rendering the media content 104 of the first bitstream 114(1) before creating a second decode device 132 and the corresponding decoding resources (e.g., input buffer(s) 134, decoder buffers 136, output buffers 138) for the second bitstream 114(2). The hardware decoder 130, if able to decode the media content 104 of the second bitstream 114(2) fast enough, can avoid a glitch in the playback using this solution.

An augmentation to avoid a potential glitch in the video playback during the transition using the techniques described herein is to copy a limited number of the last decoded frames 124 of the first bitstream 114(1) that are to be displayed into a separate reference memory for use by the client media application 118 to finish rendering those last decoded frames 124 of the first bitstream 114(1) so that the decoding resources for the first bitstream 114(1) can be removed (i.e., allocated memory for the decoding resources can be released), and the media content 104 in the second bitstream 114(2) can begin decoding to catch up to the first bitstream 114(1). The number of decoded frames 124 copied to reference memory can be kept at a small number so as to not dramatically increase memory usage and defeat the purpose of the memory reduction techniques described herein. For example, a relatively small number, such as 3 unrendered frames of the first bitstream 114(1) can be copied to reference memory so that the first decoding resources (e.g., the first output buffers 138(A), first decoder buffers 136(A), etc.) can be recycled (e.g., by shrinking or expanding the buffers to larger or smaller size buffers to accommodate the second format) or removed entirely to allocate new memory for new decoding resources of the second bitstream 114(2).

### Example Processes

The processes described herein are each illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement a process. Moreover, in some configurations, one or more blocks of a process can be omitted entirely.

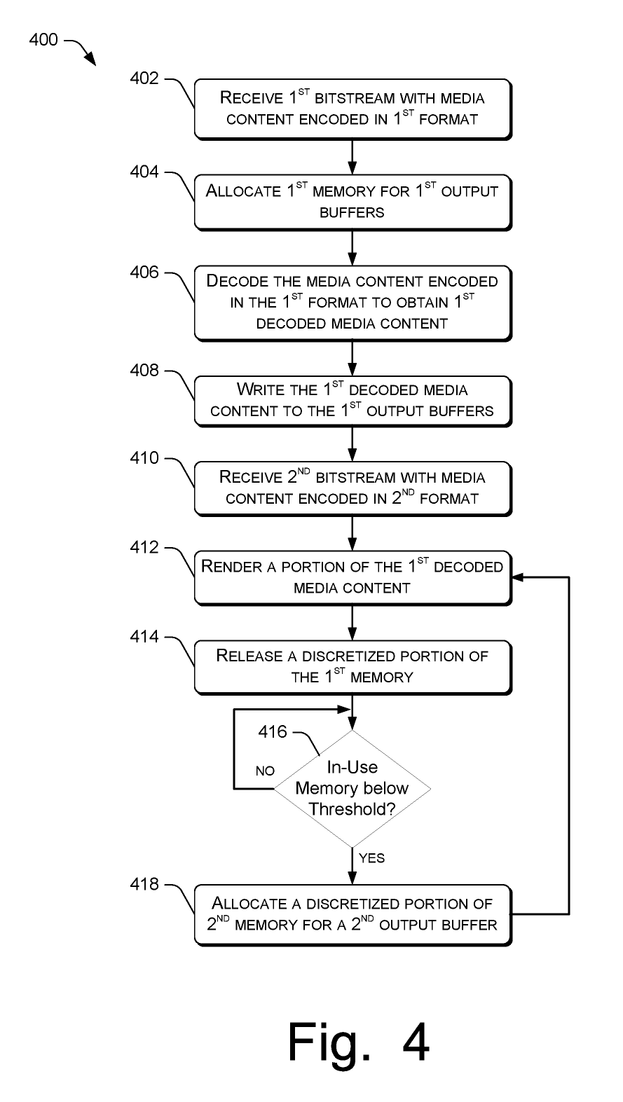

FIG. 4 is a flow diagram of an example process 400 for sequencing discretized memory allocations and release operations for output buffers 138 during a format change. The process 400 is described with reference to the architecture 100 of FIG. 1 and the schematic diagram of FIG. 2. Particular reference is made to the output buffer sequencer 140.

At 402, a first bitstream 114(1) is received at a computing device 102 configured to playback media content 104 carried in the first bitstream 114(1). The first bitstream 114(1) includes first encoded media content 104 encoded in a first format. As noted above, the format can relate to a resolution, a bitrate, a codec, an encoding/profile level, or any similar type of format parameter of the first bitstream 114(1), and any combination thereof. For example, the first format can comprise a first resolution (e.g., 1280×720 pixels) in which first video content of the first bitstream 114(1) is encoded. Furthermore, the first encoded media content 104 can comprise multiple first encoded frames 116, such as multiple encoded video frames.

At 404, first memory 200 is allocated for multiple first output buffers 138(A) associated with the first bitstream 114(1). The first memory 200 can be allocated by the decode device 132 in the OS/kernel layer 128 of the computing device 102. The number (N) of first output buffers 138(A) created, and hence, the amount of memory allocated in the first memory 200 allocated at 404, depends on the implementation. In some configurations, the number of first output buffers 138(A) depends on parameters of the first bitstream 114(1), and/or on the size or number (M) of decoder buffers 136 (e.g., DPBs) that are created for decoding the media content 104 of the first bitstream 114(1). In some configurations, the first memory 200 that is allocated at 404 comprises multiple independently-allocated (or discretized) portions of memory 202 of the computing device 102, where an independently-allocated portion corresponds to a first output buffer 138(A)(1) of the multiple first output buffers 138(A). These independently-allocated (or discretized) portions of the first memory 200 can also be released independently from other independently-allocated portions of the first memory 200. In some configurations, the entire set of N first output buffers 138(A) are allocated in a single process call by the decode device 132 at 404.

At 406, the first encoded media content 104 of the first bitstream 114(1) is decoded to obtain first decoded media content 104. The decoding of the first encoded media content 104 can be performed with acceleration using a hardware decoder 130 (e.g., a GPU). The hardware decoder 130 can receive the encoded media content 104 from an input buffer(s) 134, and output first decoded media content 104, such as in the form of decoded frames 124 (e.g., decoded video frames 124).

At 408, the first decoded media content 104 can be written to the first output buffers 138(A) and maintained in the first output buffers 138(A) until the first decoded media content 104 is output to an output device 106 (e.g., rendered on a display of the output device 106).

At 410, a second bitstream 114(2) is received at the computing device 102. The second bitstream 114(2) includes second encoded media content 104 encoded in a second format. For example, the second format can correspond to a higher resolution than the resolution of the first format, such as a higher resolution of 1920×1080 pixels.

At 412, a portion (e.g., a decoded frame(s) 124) of the first decoded media content 104 is rendered on the output device 106. Rendering the first decoded media content 104 can comprise rendering one or more decoded frames 124 on a display of the output device 106 and/or outputting decoded audio content via speakers of the output device 106, and so on.

At 414, a discretized portion of the first memory 200 can be released. Releasing the discretized portion of the first memory 200 at 414 can comprise removing one or more of the first output buffers 138(A), such as the first output buffer 138(A)(1) of FIG. 2, so that the discretized memory that was allocated for the one or more removed output buffers 138(A) is made available to other processes or applications, including the decoder 120 and the client media application 118. In an illustrative example, a decoded frame 124 can be rendered at 412, the decoded frame 124 comprising a last frame in the first output buffer 138(A)(1). If there are no more decoded frames 124 to be written to the first output buffer 138(A)(1), the first output buffer 138(A)(1) can be removed and the discretized memory allocated for the first output buffer 138(A)(1) can be released, thereby decreasing the amount of in-use memory of the computing device 102.

At 416, an output buffer sequencer 140 of the decoder 120 can determinate whether an amount of in-use memory of the computing device 102 is below a threshold amount associated with the first format. The determination at 416 can be implemented in various ways, as described herein. For example, at 416, the output buffer sequencer 140 can receive an indication that a discretized portion of the first allocated memory 200 is released at 414, indicating that an amount of in-use memory is below a threshold amount (e.g., when the threshold amount is set at the amount of memory used by the N first output buffers 138(A) maintaining decoded media content 104 of the first bitstream 114(1)). As another example, at 416, the output buffer sequencer 140 can receive an indication that a remaining in-use portion of the first memory 200 allocated at 404 is below a threshold amount. As another example, at 416, the output buffer sequencer 140 can receive an indication that an absolute (or overall) amount of in-use memory of the computing device 102 is below a threshold amount. As another example, at 416, the output buffer sequencer 140 can receive an indication that a number of decoded frames 124 of the first bitstream 114(1) that have not been output to the output device 106 is less than a threshold number. As another example, at 416, the output buffer sequencer 140 can receive an indication that a number of the remaining first output buffers 138(A) associated with the first allocated memory 200 is less than a threshold number. As another example, at 416, the output buffer sequencer 140 can receive an indication that a predetermined number of the decoded frames 124 of the first bitstream 114(1) have been deleted from one or more of the first output buffers 138(A), thus indicating that an amount of in-use memory has dropped. As another example, at 416, the output buffer sequencer 140 can receive an indication that a predetermined number of the first output buffers 138(A) have been removed, thus indicating that an amount of in-use memory has dropped.

If the determination at 416 is that the amount of in-use memory is not below a threshold amount (e.g., not below X MB of in-use memory), the process 400 proceeds along the “No” route to continue monitoring at 416 until more decoded frames 124 of the first bitstream 114(1) are rendered, and/or more allocated memory (e.g., the first memory 200) is released and made available to processes and applications of the computing device 102. Eventually, as more (e.g., additional decoded frames 124) of the first decoded media content 104 of the first bitstream 114(1) is rendered, the output buffer sequencer 140 determines that the amount of in-use memory is below a threshold amount, and proceeds along the “Yes” route to 418 where the output buffer sequencer 140 causes a discretized portion of second memory 206 to be allocated for a second output buffer(s) 138(B)(1) associated with the second bitstream 114(2). As compared to allocating the entire working set of second memory for a total number of second output buffers 138(B) to be used in decoding and rendering the second bitstream 114(2) in a single process call, the allocation at 418 represents a discretized memory allocation that can be associated with an individual second output buffer 138(B)(1) (or sometimes multiple second output buffers 138(B) when there is enough room below the threshold to allocate memory for more than one second output buffer 138(B)). This process 400 can iterate, as shown in FIG. 4 so that, as additional first decoded frames 124 of the first bitstream 114(1) are rendered, causing corresponding discretized portions of the first memory 200 to be released, additional discretized portions of the second memory 206 can be allocated for additional second output buffers 138(B) associated with the second bitstream 114(2) until a total number (Q) of second output buffers 138(B) are created, and hence an entire working set of second memory 206 is allocated, at which point, the first memory 200 is entirely released. After allocating second memory 206 for a second output buffer 138(B)(1) at 418, an encoded frame of the second bitstream 114(2) can be decoded and written to the second output buffer 138(B)(1) for rendering on the output device 106.

By waiting for memory 202 of the computing device 102 to free-up (e.g., waiting for the release of additional portions of the first allocated memory 200) and staggering the allocation of new memory for second output buffers 138(B) of the second bitstream 114(2) as additional portions of the first allocated memory 200 are released, the memory usage during a format change does not spike to an undesirable level as with existing decoders. In this manner, the process 400 effectively maintains the in-use memory of the computing device 102 below a memory “cap” during a format change so that the computing device 102 can remain functional and can playback the media content 104 without adverse effects resulting from spikes in memory usage.

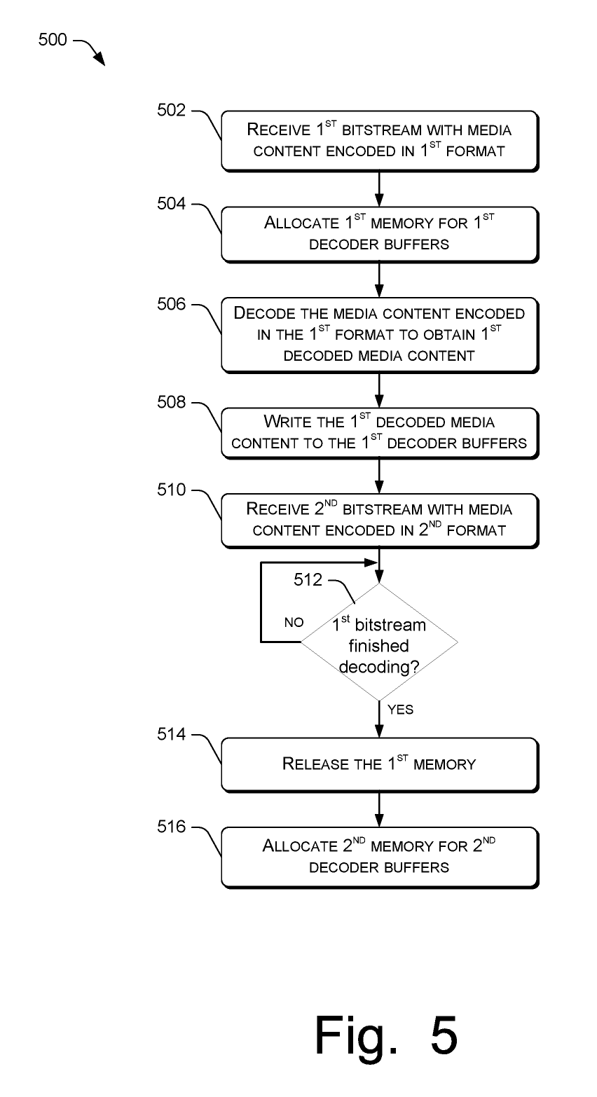

FIG. 5 is a flow diagram of an example process 500 for serializing memory release operations and allocations for decoder buffers 136 during a format change. The process 500 is described with reference to the architecture 100 of FIG. 1 and the schematic diagram of FIG. 3. Particular reference is made to the decoder buffer sequencer 142.

At 502, a first bitstream 114(1) is received at a computing device 102 configured to playback media content 104 carried in the first bitstream 114(1). The first bitstream 114(1) includes first encoded media content 104 encoded in a first format. The first encoded media content 104 can comprise multiple first encoded frames 116, such as multiple encoded video frames.

At 504, first memory 300 is allocated for multiple first decoder buffers 136(A) associated with the first bitstream 114(1). The first memory 300 can be allocated by the decode device 132 in the OS/kernel layer 128 of the computing device 102 that is “agnostic” to the format of the incoming first bitstream 114(1) such that the decode device 132 can be re-used for decoding the second bitstream 114(2) without having to instantiate a new decode device 132. The number (M) of first decoder buffers 136(A) created, and hence, the amount of memory allocated in the first allocated memory 300 at 504, depends on the implementation. In some configurations, the number of first decoder buffers 136(A) depends on parameters of the first bitstream 114(1). In some configurations, the first memory 300 that is allocated at 504 comprises multiple independently-allocated (or discretized) portions of memory 302 of the computing device 102, where an independently-allocated portion corresponds to a first decoder buffer 136(A)(1) of the multiple first decoder buffers 136(A). In some configurations, the entire set of M first decoder buffers 136(A) are allocated in a single process call by the decode device 132.

At 506, the first encoded media content 104 of the first bitstream 114(1) is decoded to obtain first decoded media content 104. The decoding of the first encoded media content 104 can be performed with acceleration using the hardware decoder 130 (e.g., a GPU). The hardware decoder 130 can be configured to support a format change internally such that the hardware decoder 130 is configured to transition from decoding the first encoded media content 104 of the first bitstream 114(1) to decoding the second encoded media content 104 of the second bitstream 114(2) on-the-fly (meaning that the hardware decoder 130 does not require a new decode device 132 to be instantiated for the second bitstream 114(2) in order to decode the media content 104 of the second bitstream 114(2)).

At 508, the first decoded media content 104 can be written to the multiple first decoder buffers 136(A) and used as reference frames in decoding subsequently received frames of the first bitstream 114(1).

At 510, a second bitstream 114(2) is received at the computing device 102. The second bitstream 114(2) includes second encoded media content 104 encoded in a second format. For example, the second format can correspond to a higher resolution than the resolution of the first format.

At 512, a determination is made by the decoder buffer sequencer 142 as to whether the encoded media content 104 of the first bitstream 114(1) has finished decoding. The determination at 512 can comprise determining that a last encoded frame 116 of the encoded frames 116 of the first bitstream 114(1) has been decoded into a last decoded frame 124 of the decoded frames 124 that are to be output on the output device 106. If it is determined that the first bitstream 114(1) is not finished decoding, meaning that a last encoded frame 116 of the first bitstream 114(1) has yet to be decoded, the process 500 loops along the “No” route to continue monitoring the status of decoding the first bitstream 114(1). Eventually, decoding operations on the first bitstream 114(1) complete and the process 500 follows the “Yes” route to 514.

At 514, the first memory 300 allocated at 504 can be released. Releasing the first memory 300 at 514 can comprise making the first memory 300 available to processes or applications executable on the computing device 102.

At 516, the decoder buffer sequencer 142 causes second memory 306 to be allocated for multiple second decoder buffer(s) 136(B) associated with the second bitstream 114(2). Additionally, the format-agnostic decode device 132 instantiated for the first bitstream 114(1) can be re-used for the second bitstream 114(2) at 516. In other words, the decode device 132 is not deleted or removed at 514 with the release of memory for the first decoder buffers 136(A), and there is no subsequent instantiation of a second decode device 132 in response to receiving the second bitstream 114(2).

Furthermore, as compared to allocating the second memory 306 for the multiple second decoder buffers 136(B) prior to release of the first memory 300 for the multiple first decoder buffers 136(A), the allocation at 516 is conditioned upon (i) the determination at 512 that the decoding operations associated with the first bitstream 114(1) have finished and (ii) that the first memory 300 allocated for the first decoder buffers 136(A) has been released at 514. By serializing the release at 514 with the allocation at 516 (i.e., releasing the first memory 300 at 514 prior to allocating the second memory 306 at 516), a memory allocation overlap condition is avoided with respect to the decoder buffers 136 used in decoding media content 104 of two different formats during a format change.

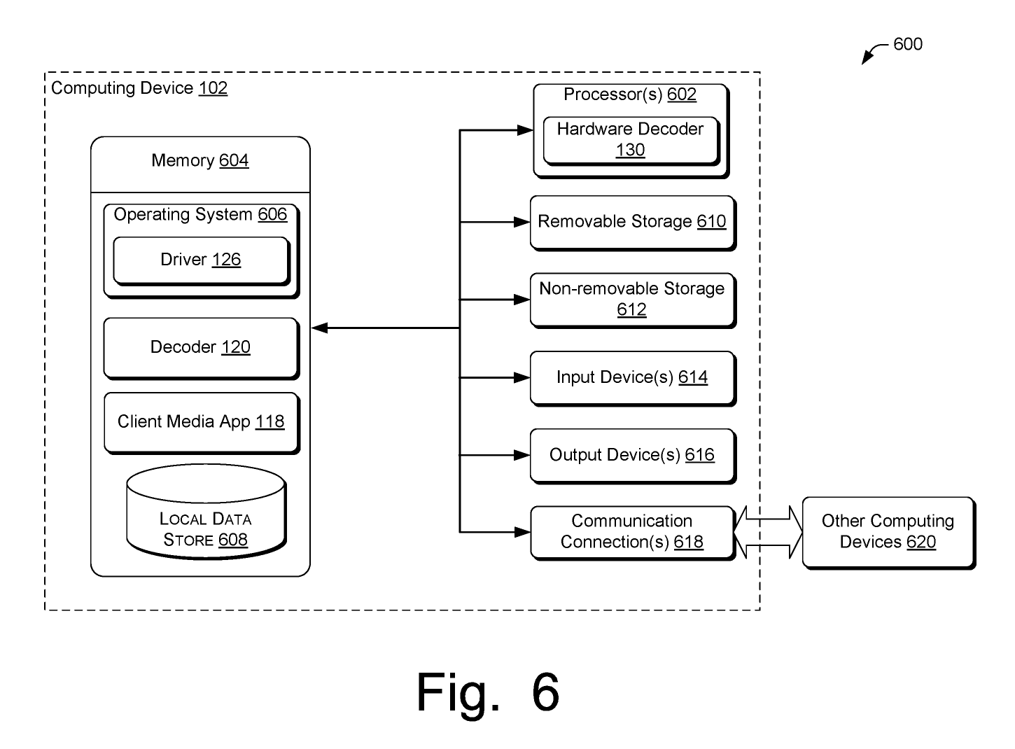

FIG. 6 is a schematic diagram of a computer architecture 600 for a computing device 102 configured to decode media content 104 according to the techniques described herein.

FIG. 6 shows the computing device 102 as including one or more processors 602 and memory 604. In some configurations, the processor(s) 602 can include hardware processors that include, without limitation, a hardware central processing unit (CPU), the hardware decoder 130 (e.g., a GPU), a field programmable gate array (FPGA), a complex programmable logic device (CPLD), an application specific integrated circuit (ASIC), a system-on-chip (SoC), or a combination thereof. Depending on the exact configuration and type of computing device, the memory 604 can be volatile (e.g., random access memory (RAM)), non-volatile (e.g., read only memory (ROM), flash memory, etc.), or some combination of the two. The memory 604 can include an operating system 606, the decoder 120, the client media application 118, and a local data store 608 that can maintain media content 104 that is accessible to the computing device 102 for playback thereon. For example, the local data store 608 can video content (e.g., recorded videos, downloaded or imported videos, and so on), audio content, and other data. The OS 606 can include the driver 126 used for decoding media content 104.

The computing device 102 can also include additional data storage devices (removable and/or non-removable) such as, for example, magnetic disks, optical disks, or tape. Such additional storage is illustrated in FIG. 6 by removable storage 610 and non-removable storage 612. Computer-readable media, as used herein, can include, at least, two types of computer-readable media, namely computer storage media and communication media. Computer storage media can include volatile and nonvolatile, removable and non-removable media implemented in any method or technology for storage of information, such as computer readable instructions, data structures, program modules, or other data. The memory 604, removable storage 610 and non-removable storage 612 are all examples of computer storage media. Computer storage media includes, but is not limited to, RAM, ROM, electrically erasable programmable read-only memory (EEPROM), flash memory or other memory technology, compact disk read-only memory (CD-ROM), digital versatile disks (DVD), or other optical storage, magnetic cassettes, magnetic tape, magnetic disk storage or other magnetic storage devices, or any other non-transmission medium that can be used to store the desired information and which can be accessed by the computing device 102. Any such computer storage media can be part of the device 102.

In some configurations, any or all of the memory 604, removable storage 610 and non-removable storage 612 can store programming instructions, data structures, program modules and other data, which, when executed by the processor(s) 602, implement some or all of the processes described herein.

In contrast, communication media can embody computer-readable instructions, data structures, program modules, or other data in a modulated data signal, such as a carrier wave, or other transmission mechanism. As defined herein, computer storage media does not include communication media.

The computing device 102 can also comprise input device(s) 614 such as a touch screen, keyboard, pointing devices (e.g., mouse, touch pad, joystick, etc.), pen, microphone, etc., through which a user can enter commands and information into the computing device 102.

The computing device 102 can further include one or more output devices 616 for providing output to a user of the computing device 102. The output device(s) 616 can include the output device 106 of FIG. 1, and can comprise, without limitation, a display, speakers, tactile feedback mechanisms, a printer, and so on. For example, a display can output decoded media content for consumption by an end user.

The computing device 102 can operate in a networked environment and, as such, the computing device 102 can further include communication connections 618 that allow the device to communicate with other computing devices 620, such as over a network (e.g., the network 112). The communication connections 618 are usable to, among other things, receive media content 104 over the network 112 from the other computing devices 620, such as the server(s) 110 of FIG. 1. Additionally, the communications connection(s) 618 can enable WiFi-based communication such as via frequencies defined by the IEEE 802.11 standards, short range wireless frequencies such as Bluetooth®, or any suitable wired or wireless communications protocol that enables the computing device 102 to interface with the other computing devices 620.

The environment and individual elements described herein can of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

### EXAMPLE ONE

A method comprising: receiving, at a computing device, a first bitstream with first encoded media content (e.g., encoded video frames, encoded audio frames, etc.) encoded in a first format (e.g., resolution, bitrate, codec (e.g., H.264, MPEG-2, etc.), encoding profile/level, etc.); allocating first memory of the computing device (e.g., a first portion of the memory of the computing device) for multiple first output buffers associated with the first bitstream; decoding the first encoded media content to obtain first decoded media content (e.g., decoded video frames, decoded audio frames, etc.); writing the first decoded media content to the multiple first output buffers; receiving a second bitstream with second encoded media content (e.g., encoded video frames, encoded audio frames, etc.) encoded in a second format (e.g., resolution, bitrate, codec (e.g., H.264, MPEG-2, etc.), encoding profile/level, etc.); in response to rendering (e.g., displaying on a display of the computing device, outputting via speakers of the computing device, etc.) a portion of the first decoded media content, releasing a portion (e.g., an independently-allocated portion corresponding to an output buffer of the multiple first output buffers) of the first memory; and in response to releasing the portion of the first memory, allocating second memory (e.g., a second independently-allocated portion of the memory of the computing device) for a second output buffer associated with the second bitstream.

### EXAMPLE TWO

The method of Example One, further comprising allocating a third portion of the memory for multiple first decoder buffers (e.g., internal decoder buffers, such as DPBs) associated with the first bitstream; writing at least some of the first decoded media content to the multiple first decoder buffers for use in decoding subsequently processed media content of the first encoded media content; initiating decoding of the second encoded media content; determining that there is no remaining encoded media content of the first encoded media content to be decoded; releasing the third portion of the memory; and in response to releasing the third portion of the memory, allocating a fourth portion of the memory for multiple second decoder buffers associated with the second bitstream.

### EXAMPLE THREE

The method of any of the previous examples, alone or in combination, further comprising obtaining capabilities of a hardware decoder (e.g., a GPU); and determining, based at least in part on the capabilities, that the hardware decoder is configured to transition from decoding the first encoded media content to decoding the second encoded media content on the fly.

### EXAMPLE FOUR

The method of any of the previous examples, alone or in combination, further comprising receiving an indication that an amount of in-use memory is below a threshold amount associated with the first format, and wherein the second portion of the memory is allocated in response to receiving the indication.

### EXAMPLE FIVE

The method of any of the previous examples, alone or in combination, wherein receiving the indication comprises comparing the threshold amount to an amount of memory corresponding to a remaining allocated portion of the first portion of the memory after releasing the portion of the first portion of the memory.

### EXAMPLE SIX

The method of any of the previous examples, alone or in combination, wherein receiving the indication comprises: determining an amount of the first decoded media content that has not been rendered on a display; and determining that the amount of the first decoded media content is less than a threshold amount of media content.

### EXAMPLE SEVEN

A system comprising: one or more processors (e.g., central processing units (CPUs), field programmable gate array (FPGAs), complex programmable logic devices (CPLDs), application specific integrated circuits (ASICs), system-on-chips (SoCs), etc.); and memory (e.g., RAM, ROM, EEPROM, flash memory, etc.) storing computer-executable instructions that, when executed by the one or more processors, cause performance of operations comprising: receiving a first bitstream with first encoded media content (e.g., encoded video frames, encoded audio frames, etc.) encoded in a first format (e.g., resolution, bitrate, codec (e.g., H.264, MPEG-2, etc.), encoding profile/level, etc.); allocating a first portion of the memory for multiple first output buffers associated with the first bitstream; decoding the first encoded media content to obtain first decoded media content (e.g., decoded video frames, decoded audio frames, etc.); writing the first decoded media content to the multiple first output buffers; receiving a second bitstream with second encoded media content encoded video frames, encoded audio frames, etc.) encoded in a second format (e.g., resolution, bitrate, codec (e.g., H.264, MPEG-2, etc.), encoding profile/level, etc.); in response to rendering (e.g., displaying on a display of the computing device, outputting via speakers of the computing device, etc.) a portion of the first decoded media content, releasing a portion (e.g., an independently-allocated portion corresponding to an output buffer of the multiple first output buffers) of the first portion of the memory; and in response to releasing the portion of the first portion of the memory, allocating a second portion (e.g., an independently-allocated portion) of the memory for a second output buffer associated with the second bitstream.

### EXAMPLE EIGHT

The system of Example Seven, the operations further comprising allocating a third portion of the memory for multiple first decoder buffers (e.g., internal decoder buffers, such as DPBs) associated with the first bitstream; writing at least some of the first decoded media content to the multiple first decoder buffers for use in decoding subsequently processed media content of the first encoded media content; initiating decoding of the second encoded media content; determining that there is no remaining encoded media content of the first encoded media content to be decoded; releasing the third portion of the memory; and in response to releasing the third portion of the memory, allocating a fourth portion of the memory for multiple second decoder buffers associated with the second bitstream.

### EXAMPLE NINE

The system of any of the previous examples, alone or in combination, the operations further comprising obtaining capabilities of a hardware decoder (e.g., a GPU); and determining, based at least in part on the capabilities, that the hardware decoder is configured to transition from decoding the first encoded media content to decoding the second encoded media content on the fly.

### EXAMPLE TEN

The system of any of the previous examples, alone or in combination, the operations further comprising receiving an indication that an amount of in-use memory is below a threshold amount associated with the first format, and wherein the second portion of the memory is allocated in response to receiving the indication.

### EXAMPLE ELEVEN

The system of any of the previous examples, alone or in combination, wherein receiving the indication comprises comparing the threshold amount to an amount of memory corresponding to a remaining allocated portion of the first portion of the memory after releasing the portion of the first portion of the memory.

### EXAMPLE TWELVE

The system of any of the previous examples, alone or in combination, wherein receiving the indication comprises: determining an amount of the first decoded media content that has not been rendered on a display; and determining that the amount of the first decoded media content is less than a threshold amount of media content.

### EXAMPLE THIRTEEN

A method comprising: receiving, at a computing device, a first bitstream with multiple first encoded video frames encoded in a first format; allocating first memory of the computing device for multiple first output buffers associated with the first bitstream; decoding the multiple first encoded video frames to obtain multiple first decoded video frames; writing the multiple first decoded video frames to the multiple first output buffers, the multiple first decoded video frames occupying a first amount of in-use memory of the first memory; receiving, at the computing device, a second bitstream with multiple second encoded video frames encoded in a second format; rendering a video frame of the multiple first decoded video frames on a display; releasing a portion of the first memory in response to rendering the video frame; receiving an indication that a second amount of the in-use memory of the first memory resulting from the portion of the first memory being released is below a threshold amount, wherein the threshold amount is based at least in part on the first format; and in response to receiving the indication, allocating second memory for a second output buffer associated with the second bitstream.

### EXAMPLE FOURTEEN

The method of Example Thirteen, wherein the first format corresponds to a first resolution of the first bitstream and the second format corresponds to a second resolution of the second bitstream, the first resolution being less than the second resolution.

### EXAMPLE FIFTEEN

The method of any of the previous examples, alone or in combination, wherein the first memo that is allocated for the multiple first output buffers comprises multiple dependently-allocated portions of memory of the computing device, an independently-allocated portion of the multiple independently-allocated portions corresponding to a first output buffer of the multiple first output buffers, and wherein releasing the portion of the first memory comprises releasing the independently-allocated portion corresponding to the first output buffer.

### EXAMPLE SIXTEEN

The method of any of the previous examples, alone or in combination, wherein the second memory that is allocated for the second output buffer comprises an independently-allocated portion of memory of the computing device that corresponds to the second output buffer, the method further comprising incrementally allocating individual portions of the memory for additional second output buffers associated with the second bitstream in response to subsequently received indications that a remaining amount of the in-use memory of the first memory drops, or remains, below the threshold amount.

### EXAMPLE SEVENTEEN

The method of any of the previous examples, alone or in combination, further comprising determining the threshold amount by referencing a lookup table and identifying the threshold amount corresponding to the first format.

### EXAMPLE EIGHTEEN

The method of any of the previous examples, alone or in combination, further comprising receiving an additional indication that an absolute amount of in-use memory of the computing device is below an additional threshold amount, wherein allocating the second memory is conditioned on the absolute amount of the in-use memory of the computing device being below the additional threshold amount.

### EXAMPLE NINETEEN

The method of any of the previous examples, alone or in combination, wherein receiving the indication comprises: determining a number of video frames of the multiple first decoded video frames that have not been rendered on the display; and determining that the number of video frames is less than a threshold number.

### EXAMPLE TWENTY

The method of any of the previous examples, alone or in combination, wherein receiving the indication comprises: determining a number of output buffers of the multiple first output buffers that remain available after releasing the portion of the first memory; and determining that the number of output buffers is less than a threshold number.

### EXAMPLE TWENTY-ONE

A system comprising: one or more processors (e.g., central processing units (CPUs), field programmable gate array (FPGAs), complex programmable logic devices (CPLDs), application specific integrated circuits (ASICs), system-on-chips (SoCs), etc.); and memory (e.g., RAM, ROM, EEPROM, flash memory, etc.) storing computer-executable instructions that, when executed by the one or more processors, cause performance of operations comprising: receiving a first bitstream with multiple first encoded video frames encoded in a first format; allocating a first portion of the memory for multiple first output buffers associated with the first bitstream; decoding the multiple first encoded video frames to obtain multiple first decoded video frames; writing the multiple first decoded video frames to the multiple first output buffers, the multiple first decoded video frames occupying a first amount of in-use memory of the first portion of the memory; receiving a second bitstream with multiple second encoded video frames encoded in a second format; rendering a video frame of the multiple first decoded video frames on a display; releasing a portion of the first portion of the memory in response to rendering the video frame; receiving an indication that a second amount of the in-use memory of the first portion of the memory resulting from the portion of the first portion of the memory being released is below a threshold amount, wherein the threshold amount is based at least in part on the first format; in response to receiving the indication, allocating a second portion of the memory for a second output buffer associated with the second bitstream.

### EXAMPLE TWENTY-TWO

A method comprising: receiving,at a computing device, a first bitstream with multiple first encoded video frames encoded in a first format (e.g., resolution, bitrate, codec (e.g., H.264, MPEG-2, etc.), encoding profile/level, etc.); allocating first memory, of the computing device, for multiple first decoder buffers (e.g., internal decoder buffers, such as DPBs) associated with the first bitstream; decoding the multiple first encoded video frames to obtain multiple first decoded video frames; writing at least some of the multiple first decoded video frames to the multiple first decoder buffers for use in decoding subsequently processed video frames of the multiple first encoded video frames; receiving, at the computing device, a second bitstream with multiple second encoded video frames encoded in a second format; determining that a last encoded video frame of the multiple first encoded video frames has been decoded into a last decoded video frame of the multiple first decoded video frames; releasing the first memory; and in response to releasing the first memory, allocating second memory, of the computing device, for multiple second decoder buffers associated with the second bitstream.

### EXAMPLE TWENTY-THREE

The method of Example Twenty-Two, wherein the multiple first decoder buffers comprise multiple first decoded picture buffers (DPBs) and the multiple second decoder buffers comprise multiple second DPBs.

### EXAMPLE TWENTY-FOUR

The method of any of the previous examples, alone or in combination, further comprising, prior to allocating the second memory: allocating additional memory for a format-agnostic decode device; using the format-agnostic decode device for decoding the multiple first encoded video frames; and re-using the format-agnostic decode device for decoding the multiple second encoded video frames.

### EXAMPLE TWENTY-FIVE

The method of any of the previous examples, alone or in combination, further comprising: allocating third memory for multiple first output buffers associated with the first bitstream; writing the multiple first decoded video frames to the multiple first output buffers; in response to rendering a video frame of the multiple first decoded video frames on a display, releasing a portion of the third memory; and in response to releasing the portion of the third portion of the memory, allocating fourth memory for a second output buffer associated with the second bitstream.

### EXAMPLE TWENTY-SIX

The method of any of the previous examples, alone or in combination, further comprising receiving an indication that an amount of in-use memory is below a threshold amount associated with the first format, and wherein the fourth memory is allocated in response to receiving the indication.

### EXAMPLE TWENTY-SEVEN

The method of any of the previous examples, alone or in combination, wherein receiving the indication comprises: determining a number of video frames of the multiple first decoded video frames that have not been rendered on the display; and determining that the number of video frames is less than a threshold number.

### EXAMPLE TWENTY-EIGHT

A system comprising: one or more processors (e.g., central processing units (CPUs), field programmable gate array (FPGAs), complex programmable logic devices (CPLDs), application specific integrated circuits (ASICs), system-on-chips (SoCs), etc.); and memory (e.g., RAM, ROM, EEPROM, flash memory, etc.) storing computer-executable instructions that, when executed by the one or more processors, cause performance of operations comprising: receiving first bitstream with multiple first encoded video frames encoded in a first format (e.g., resolution, bitrate, codec (e.g., H.264, MPEG-2, etc.), encoding profile/level, etc.); allocating a first portion of the memory for multiple first decoder buffers (e.g., internal decoder buffers, such as DPBs) associated with the first bitstream; decoding the multiple first encoded video frames to obtain multiple first decoded video frames; writing at least some of the multiple first decoded video frames to the multiple first decoder buffers for use in decoding subsequently processed video frames of the multiple first encoded video frames; receiving a second bitstream with multiple second encoded video frames encoded in a second format; determining that a last encoded video frame of the multiple first encoded video frames has been decoded into a last decoded video frame of the multiple first decoded video frames; releasing the first portion of the memory; and in response to releasing the first portion of the memory, allocating a second portion of the memory for multiple second decoder buffers associated with the second bitstream.

### EXAMPLE TWENTY-NINE

The system of Example Twenty-Eight, wherein the multiple first decoder buffers comprise multiple first decoded picture buffers (DPBs) and the multiple second decoder buffers comprise multiple second DPBs.

### EXAMPLE THIRTY

The system of any of the previous examples, alone or in combination, the operations further comprising, prior to allocating the second memory: allocating additional memory for a format-agnostic decode device; using the format-agnostic decode device for decoding the multiple first encoded video frames; arid re-using the format-agnostic decode device for decoding the multiple second encoded video frames.

### EXAMPLE THIRTY-ONE

The system of any of the previous examples, alone or in combination, the operations further comprising: allocating third memory for multiple first output buffers associated with the first bitstream; writing the multiple first decoded video frames to the multiple first output buffers; in response to rendering a video frame of the multiple first decoded video frames on a display, releasing a portion of the third memory; and in response to releasing the portion of the third portion of the memory, allocating fourth memory for a second output buffer associated with the second bitstream.

### EXAMPLE THIRTY-TWO

The system of any of the previous examples, alone or in combination, the operations further comprising receiving an indication that an amount of in-use memory is below a threshold amount associated with the first format, and wherein the fourth memory is allocated in response to receiving the indication.

### EXAMPLE THIRTY-THREE

The system of any of the previous examples, alone or in combination, wherein receiving the indication comprises: determining a number of video frames of the multiple first decoded video frames that have not been rendered on the display; and determining that the number of video frames is less than a threshold number.

### EXAMPLE THIRTY-FOUR

One or more computer-readable storage media (e.g., RAM, ROM, EEPROM, flash memory, etc.) storing computer-executable instructions that, when executed by a processor (e.g., central processing unit (CPU), a field programmable gate array (FPGA), a complex programmable logic device (CPLD), an application specific integrated circuit (ASIC), a system-on-chip (SoC), etc.), perform operations comprising: receiving, at a computing device, a first bitstream with first encoded media content (e.g., encoded video frames, encoded audio frames, etc.) encoded in a first format (e.g., resolution, bitrate, codec (e.g., H.264, MPEG-2, etc.), encoding profile/level, etc.); allocating first memory of the computing device (e.g., a first portion of the memory of the computing device) for multiple first output buffers associated with the first bitstream; decoding the first encoded media content to obtain first decoded media content (e.g., decoded video frames, decoded audio frames, etc.); writing the first decoded media content to the multiple first output buffers; receiving a second bitstream with second encoded media content (e.g., encoded video frames, encoded audio frames, etc.) encoded in a second format (e.g., resolution, bitrate, codec (e.g., H.264, MPEG-2, etc.), encoding profile/level, etc.); in response to rendering (e.g., displaying on a display of the computing device, outputting via speakers of the computing device, etc.) a portion of the first decoded media content, releasing a portion (e.g., an independently-allocated portion corresponding to an output buffer of the multiple first output buffers) of the first memory; and in response to releasing the portion of the first memory, allocating second memory (e.g., a second independently-allocated portion of the memory of the computing device) for a second output buffer associated with the second bitstream.

### EXAMPLE THIRTY-FIVE

One or more computer-readable storage media (e.g., RAM, ROM, EEPROM, flash memory, etc.) storing computer-executable instructions that, when executed by a processor (e.g., central processing unit (CPU), a field programmable gate array (FPGA), a complex programmable logic device (CPLD), an application specific integrated circuit (ASIC), a system-on-chip (SoC), etc.), perform operations comprising: receiving, at a computing device, a first bitstream with multiple first encoded video frames encoded in a first format; allocating first memory of the computing device for multiple first output buffers associated with the first bitstream; decoding the multiple first encoded video frames to obtain multiple first decoded video frames; writing the multiple first decoded video frames to the multiple first output buffers, the multiple first decoded video frames occupying a first amount of in-use memory of the first memory; receiving, at the computing device, a second bitstream with multiple second encoded video frames encoded in a second format; rendering a video frame of the multiple first decoded video frames on a display; releasing a portion of the first memory in response to rendering the video frame; receiving an indication that a second amount of the in-use memory of the first memory resulting from the portion of the first memory being released is below a threshold amount, wherein the threshold amount is based at least in part on the first format; and in response to receiving the indication, allocating second memory for a second output buffer associated with the second bitstream.

### EXAMPLE THIRTY-SIX

One or more computer-readable storage media (e.g., RAM, ROM, EEPROM, flash memory, etc.) storing computer-executable instructions that, when executed by a processor (e.g., central processing unit (CPU), a field programmable gate array (FPGA), a complex programmable logic device (CPLD), an application specific integrated circuit (ASIC), a system-on-chip (SoC), etc.), perform operations comprising: receiving, at a computing device, a first bitstream with multiple first encoded video frames encoded in a first format (resolution, bitrate, codec (e.g., H.264, MPEG-2, etc.), encoding profile/level, etc.); allocating first memory, of the computing device, for multiple first decoder buffers (e.g., internal decoder buffers, such as DPBs) associated with the first bitstream; decoding the multiple first encoded video frames to obtain multiple first decoded video frames; writing at least some of the multiple first decoded video frames to the multiple first decoder buffers for use in decoding subsequently processed video frames of the multiple first encoded video frames; receiving, at the computing device, a second bitstream with multiple second encoded video frames encoded in a second format; determining that a last encoded video frame of the multiple first encoded video frames has been decoded into a last decoded video frame of the multiple first decoded video frames; releasing the first memory; and in response to releasing the first memory, allocating second memory, of the computing device, for multiple second decoder buffers associated with the second bitstream.

### EXAMPLE THIRTY-SEVEN

A system comprising: means for executing computer-executable instructions (e.g., central processing unit (CPU), a field programmable gate array (FPGA), a complex programmable logic device (CPLD), an application specific integrated circuit (ASIC), a system-on-chip (SoC), etc.); and means for storing (e.g., RAM, ROM, EEPROM, flash memory, etc.) instructions that, when executed by the means for executing computer-executable instructions, perform operations comprising: receiving a first bitstream with first encoded media content (e.g., encoded video frames, encoded audio frames, etc.) encoded in a first format (e.g., resolution, bitrate, codec (e.g., H.264, MPEG-2, etc.), encoding profile/level, etc.); allocating a first portion of the means for storing for multiple first output buffers associated with the first bitstream; decoding the first encoded media content to obtain first decoded media content (e.g., decoded video frames, decoded audio frames, etc.); writing the first decoded media content to the multiple first output buffers; receiving a second bitstream with second encoded media content (e.g., encoded video frames, encoded audio frames, etc.) encoded in a second format (e.g., resolution, bitrate, codec (e.g., H.264, MPEG-2, etc.), encoding profile/level, etc.); in response to rendering (e.g., displaying on a display of the computing device, outputting via speakers of the computing device, etc.) a portion of the first decoded media content, releasing a portion (e.g., an independently-allocated portion corresponding to an output buffer of the multiple first output buffers) of the first portion of the means for storing; and in response to releasing the portion of the first portion of the means for storing, allocating a second portion (e.g., an independently-allocated portion) of the means for storing for a second output buffer associated with the second bitstream.

### EXAMPLE THIRTY-EIGHT

A system comprising: means for executing computer-executable instructions (e.g., central processing unit (CPU), a field programmable gate array (FPGA), a complex programmable logic device (CPLD), an application specific integrated circuit (ASIC), a system-on-chip (SoC), etc.); and means for storing (e.g., RAM, ROM, EEPROM, flash memory, etc.) instructions that, when executed by the means for executing computer-executable instructions, perform operations comprising: receiving a first bitstream with multiple first encoded video frames encoded in a first format; allocating a first portion of the means for storing for multiple first output buffers associated with the first bitstream; decoding the multiple first encoded video frames to obtain multiple first decoded video frames; writing the multiple first decoded video frames to the multiple first output buffers, the multiple first decoded video frames occupying a first amount of in-use memory of the first portion of the means for storing; receiving a second bitstream with multiple second encoded video frames encoded in a second format; rendering a video frame of the multiple first decoded video frames on a display; releasing a portion of the first portion of the means for storing in response to rendering the video frame; receiving an indication that a second amount of the in-use memory of the first portion of the means for storing resulting from the portion of the first portion of the means for storing being released is below a threshold amount, wherein the threshold amount is based at least in part on the first format; in response to receiving the indication, allocating a second portion of the means for storing for a second output buffer associated with the second bitstream.

### EXAMPLE THIRTY-NINE

A system comprising: means for executing computer-executable instructions (e.g., central processing unit (CPU), a field programmable gate array (FPGA), a complex programmable logic device (CPLD), an application specific integrated circuit (ASIC), a system-on-chip (SoC), etc.); and means for storing (e.g., RAM, ROM, EEPROM, flash memory, etc.) instructions that, when executed by the means for executing computer-executable instructions, perform operations comprising: receiving a first bitstream h multiple first encoded video frames encoded in a first format resolution, bitrate, codec (e.g., H.264, MPEG-2, etc.), encoding profile/level, etc.); allocating a first portion of the means for storing for multiple first decoder buffers (e.g., internal decoder buffers, such as DPBs) associated with the first bitstream; decoding the multiple first encoded video frames to obtain multiple first decoded video frames; writing at least some of the multiple first decoded video frames to the multiple first decoder buffers for use in decoding subsequently processed video frames of the multiple first encoded video frames; receiving a second bitstream with multiple second encoded video frames encoded in a second format; determining that a last encoded video frame of the multiple first encoded video frames has been decoded into a last decoded video frame of the multiple first decoded video frames; releasing the first portion of the means for storing; and in response to releasing the first portion of the means for storing, allocating a second portion of the means for storing for multiple second decoder buffers associated with the second bitstream.

### Conclusion

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving, at a computing device, a first bitstream with multiple first encoded video frames encoded in a first format;
allocating first memory of the computing device for multiple first output buffers associated with the first bitstream;
decoding the multiple first encoded video frames o obtain multiple first decoded video frames;
writing the multiple first decoded video frames to the multiple first output buffers, the multiple first decoded video frames occupying a first amount of in-use memory of the first memory;
receiving, at the computing device, a second bitstream with multiple second encoded video frames encoded in a second format;
rendering a video frame of the multiple first decoded video frames on a display;
releasing a portion of the first memory in response to rendering the video frame;
receiving an indication that a second amount of the in-use memory of the first memory resulting from the portion of the first memory being released is below a threshold amount, wherein the threshold amount is based at least in part on the first format; and
in response to receiving the indication, allocating second memory for a second output buffer associated with the second bitstream.

2. The method of claim 1, wherein the first format corresponds to a first resolution of the first bitstream and the second format corresponds to a second resolution of the second bitstream, the first resolution being less than the second resolution.

3. The method of claim 1, wherein the first memory that is allocated for the multiple first output buffers comprises multiple independently-allocated portions of memory of the computing device, an independently-allocated portion of the multiple independently-allocated portions corresponding to a first output buffer of the multiple first output buffers, and wherein releasing the portion of the first memory comprises releasing the independently-allocated portion corresponding to the first output buffer.

4. The method of claim 1, wherein the second memory that is allocated for the second output buffer comprises an independently-allocated portion of memory of the computing device that corresponds to the second output buffer, the method further comprising incrementally allocating individual portions of the memory for additional second output buffers associated with the second bitstream in response to subsequently received indications that a remaining amount of the in-use memory of the first memory drops, or remains, below the threshold amount.

5. The method of claim 1, further comprising determining the threshold amount by referencing a lookup table and identifying the threshold amount corresponding to the first format.

6. The method of claim 1, further comprising receiving an additional indication that an absolute amount of in-use memory of the computing device is below an additional threshold amount, wherein allocating the second memory is conditioned on the absolute amount of the in-use memory of the computing device being below the additional threshold amount.

7. The method of claim 1, wherein receiving the indication comprises:
determining a number of video frames of the multiple first decoded video frames that have not been rendered on the display; and
determining that the number of video frames is less than a threshold number.

8. The method of claim 1, wherein receiving the indication comprises:
determining a number of output buffers of the multiple first output buffers that remain available after releasing the portion of the first memory; and
determining that the number of output buffers is less than a threshold number.

9. A system comprising:
one or more processors; and
memory storing computer-executable instructions that, when executed by the one or more processors, cause performance of operations comprising:
receiving a first bitstream with first encoded media content coded in a first format;
allocating a first portion of the memory for multiple first output buffers associated with the first bitstream;
decoding the first encoded media content to obtain first decoded media content;
writing the first decoded media content to the multiple first output buffers;
receiving a second bitstream with second encoded media content encoded in a second format;
in response to rendering a portion of the first decoded media content, releasing a portion of the first portion of the memory; and
in response to releasing the portion of the first portion of the memory, allocating a second portion of the memory for a second output buffer associated with the second bitstream.

10. The system of claim 9, the operations further comprising:
allocating a third portion of the memory for multiple first decoder buffers associated with the first bitstream;
writing at least some of the first decoded media content to the multiple first decoder buffers for use in decoding subsequently processed media content of the first encoded media content;
initiating decoding of the second encoded media content;
determining that there is no remaining encoded media content of the first encoded media content to be decoded;
releasing the third portion of the memory; and
in response to releasing the third portion of the memory, allocating a fourth portion of the memory for multiple second decoder buffers associated with the second bitstream.

11. The system of claim 9, further comprising a hardware decoder, the operations further comprising:
obtaining capabilities of the hardware decoder; and
determining, based at least in part on the capabilities, that the hardware decoder is configured to transition from decoding the first encoded media content to decoding the second encoded media content on the fly.

12. The system of claim 9, the operations further comprising:
receiving an indication that an amount of in-use memory is below a threshold amount associated with the first format, and wherein the second portion of the memory is allocated in response to receiving the indication.

13. The system of claim 12, wherein receiving the indication comprises comparing the threshold amount to an amount of memory corresponding to a remaining allocated portion of the first portion of the memory after releasing the portion of the first portion of the memory.

14. The system of claim 12, wherein receiving the indication comprises:
determining an amount of the first decoded media content that has not been rendered on a display; and
determining that the amount of the first decoded media content is less than a threshold amount of media content.

15. A method comprising:
receiving, at a computing device, a first bitstream with multiple encoded video frames encoded in a first format;
allocating first memory, of the computing device, for multiple first decoder buffers associated with the first bitstream;
decoding the multiple first encoded video frames to obtain multiple first decoded video frames;
writing at least some of the multiple first decoded video frames to the multiple first decoder buffers for use in decoding subsequently processed video frames of the multiple first encoded video frames;
receiving, at the computing device, a second bitstream with multiple second encoded video frames encoded in a second format;
determining that a last encoded video frame of the multiple first encoded video frames has been decoded into a last decoded video frame of the multiple first decoded video frames;
releasing the first memory; and
in response to releasing the first memory, allocating second memory, of the computing device, for multiple second decoder buffers associated with the second bitstream.

16. The method of claim 15, wherein the multiple first decoder buffers comprise multiple first decoded picture buffers (DPBs) and the multiple second decoder buffers comprise multiple second DPBs.

17. The method of claim 15, further comprising, prior to allocating the second memory:
allocating additional memory for a format-agnostic decode device;
using the format-agnostic decode device for decoding the multiple first encoded video frames; and
re-using the format-agnostic decode device for decoding the multiple second encoded video frames.

18. The method of claim 15, further comprising:
allocating third memory for multiple first output buffers associated with the first bitstream;
writing the multiple first decoded video frames to the multiple first output buffers;
in response to rendering a video frame of the multiple first decoded video frames on a display, releasing a portion of the third memory; and
in response to releasing the portion of the third portion of the memory, allocating fourth memory for a second output buffer associated with the second bitstream.

19. The method of claim 18, further comprising:
receiving an indication that an amount of in-use memory is below a threshold amount associated with the first format, and wherein the fourth memory is allocated in response to receiving the indication.

20. The method of claim 19, wherein receiving the indication comprises:
determining a number of video frames of the multiple first decoded video frames that have not been rendered on the display; and
determining that the number of video frames is less than a threshold number.
